(19) United States
(12) Patent Application Publication
(10) Pub. No.: US 2026/0351707 A1
(43) Pub. Date: Nov. 5, 2026

(54) BATTERY MANAGEMENT SYSTEM FOR HIGH-VOLTAGE BATTERY MODULES AND BATTERY PACKS USED IN BATTERY ENERGY STORAGE SYSTEM (BESS) DC BLOCKS, AND APPLICATIONS THEREOF

(71) Applicant: VLTRU Technologies, Inc., Tualatin, OR (US)

(72) Inventor: Virgil L. BEASTON, Vestal, NY (US)

(73) Assignee: VLTRU Technologies, Inc., Tualatin, OR (US)

(21) Appl. No.: 19/743,971

(22) Filed: Jul. 16, 2026

Related U.S. Application Data
(63) Continuation-in-part of application No. 17/966,500, filed on Oct. 14, 2022, now Pat. No. 12,712,215.
Application No. 17/966,500 is a continuation-in-part of application No. 17/691,948, filed on Mar. 10, 2022, now Pat. No. 12,567,614.
Application No. 17/691,948 is a continuation of application No. PCT/US2022/013290, filed on Jan. 21, 2022.
Application No. PCT/US2022/013290 is a continuation of application No. 17/531,378, filed on Nov. 19, 2021, now Pat. No. 11,901,532.
(60) Provisional application No. 63/123,458, filed on Dec. 9, 2020.
(60) Provisional application No. 63/125,958, filed on Dec. 15, 2020.
(60) Provisional application No. 63/164,502, filed on Mar. 22, 2021.
(60) Provisional application No. 63/170,600, filed on Apr. 5, 2021.
(60) Provisional application No. 63/211,732, filed on Jun. 17, 2021.

(51) Int. Cl. H01M 10/613; H01M 50/24

(52) U.S. Cl. CPC H01M 10/613; H01M 50/24; H01M 2220/10

(57) ABSTRACT

A battery management system for high-voltage battery packs and containerized energy storage systems monitors cell voltages, temperatures, and mechanical conditions such as pressure, strain, or swelling to detect early failure conditions. The system includes a battery module controller with sensing circuitry, communication interfaces, and active cell-balancing circuitry. In one embodiment, cell balancing is performed using high-frequency AC power derived from an external source, enabling efficient balancing without drawing energy from the battery cells. The controller determines cell metrics, including highest, lowest, average, and delta values, and controls balancing and safety functions based on these parameters. Upon detecting abnormal mechanical or thermal conditions, the system can inhibit charging or discharging and initiate protective actions. The architecture supports modular battery packs and rack-level coordination within containerized battery energy storage systems.

### CROSS-REFERENCE TO RELATED APPLICATIONS

This application is a continuation-in-part application of U.S. application Ser. No. 17/966,500, Oct. 14, 2022, which is a continuation-in-part application of U.S. application Ser. No. 17/691,948, filed Mar. 10, 2022, now U.S. Pat. No. 12,567,614, which is a continuation application of PCT International Application No. PCT/US2022/013290, filed Jan. 21, 2022; which is a continuation application of U.S. application Ser. No. 17/531,378, filed Nov. 19, 2021, now U.S. Pat. No. 11,901,532, which claims the benefit of U.S. Provisional Patent Application 63/211,732, filed Jun. 17, 2021, U.S. Provisional Patent Application 63/170,600, filed Apr. 5, 2021; U.S. Provisional Patent Application 63/164,502, filed Mar. 22, 2021, U.S. Provisional Patent Application 63/125,958, filed Dec. 15, 2020, and U.S. Provisional Patent Application 63/123,458, filed Dec. 9, 2020. Each of the above applications is herein incorporated by reference as if fully reproduced below.

### TECHNICAL FIELD

The present disclosure relates to battery modules, battery management systems, and battery energy storage systems.

### BACKGROUND

Battery energy storage systems use a lot of batteries, typically assembled into battery modules and battery packs. The trend has been to make these battery modules and battery packs larger and larger in an effort to reduce overall system costs. Accordingly, it is common for multi-megawatt-hour containerized battery energy storage systems such as, for example, a 5 MWh BESS DC block to be built using dozens of 100 kWh high-voltage battery modules or battery packs. Unfortunately, conventional battery management systems for these large battery packs have not kept up and are not able to balance the battery cells of these large battery modules and battery packs.

In addition to not being able to properly balance large battery modules and battery packs, conventional battery management systems typically just monitor battery cell voltages and temperatures. They do not monitor or indicate the internal state of the battery cells. Battery cell voltages as well as cell temperatures are not in themselves good indicators of changing conditions/pressure inside the cells that can lead to a battery fire.

### SUMMARY

The embodiments featured herein help solve or mitigate the above-mentioned issues as well as additional shortcomings relating to battery storage systems.

The present disclosure relates to battery management technology for high-voltage battery modules, battery packs, and containerized battery energy storage systems. In these systems, conventional battery management approaches are limited because they primarily rely on voltage and temperature measurements and do not adequately detect internal physical changes within cells that can precede hazardous events. The disclosed technology addresses those shortcomings by combining electrical monitoring, thermal monitoring, and mechanical-condition monitoring in a coordinated battery management architecture for large-scale energy storage installations.

In one aspect, the technology uses a battery module controller located at or near a service-accessible region of a battery pack to supervise operation of the pack at the cell level. The controller may gather measurements of individual cell voltages, pack voltage, pack current, cell temperature, coolant temperature, service-disconnect status, and mechanical-condition data such as strain, pressure, or swelling. By evaluating these different categories of data together, the controller can identify not only electrical imbalance and thermal irregularities, but also early mechanical signs of cell degradation, gas generation, or unsafe internal cell conditions that may not yet be apparent from voltage or temperature alone.

In another aspect, the technology introduces an active balancing approach that uses externally supplied high-frequency AC power rather than relying only on energy drawn from the battery cells themselves. Grid power may be received through an AC input, filtered and rectified, processed through a quasi-resonant power stage, and delivered through isolation transformers and rectifier circuitry to balancing channels that supply regulated balancing current to selected cells. This arrangement permits efficient balancing while providing galvanic isolation, reducing reliance on passive resistive dissipation, and allowing balancing operations during charging, discharging, or idle conditions without unnecessarily depleting stored battery energy.

The technology also incorporates mechanical-condition sensing as an important safety input. Pressure sensors, strain gauges, load sensors, or related devices may be positioned within or adjacent to cells, compression structures, or pack enclosures to detect swelling, deformation, or pressure buildup associated with electrolyte decomposition, gas generation, lithium plating, or other precursor conditions. Because those changes can arise before a dangerous event becomes visible in temperature or voltage data, the disclosed arrangements allow the controller to respond earlier by limiting operation, stopping balancing, isolating the pack, issuing alarms, or halting charging and discharging until the affected module can be inspected or replaced.

The disclosed architecture is also designed for modular deployment in rack-level and container-level energy storage systems. Individual battery packs may include front-service electrical connectors, communication and power interfaces, coolant quick-disconnect fittings, and manual service disconnects that allow installation, isolation, replacement, and maintenance from the service side of the system. Rack-level controllers may aggregate pack data, communicate with module controllers over CAN-based links, distribute grid power used for balancing functions, monitor rack current and voltage, and operate contactors to connect or isolate battery racks from the system DC bus in response to detected fault conditions.

Further, the software and user-interface aspects of the system support practical monitoring and diagnostics by presenting cell-level and pack-level information in a manner that highlights operating divergence across the battery pack. The system may determine and display highest, average, lowest, and delta values for voltage, temperature, and pressure or related mechanical-condition data, allowing service personnel or supervisory controllers to identify cell imbalance, localized heating, cooling-system problems, abnormal compression, or cell swelling more quickly. In this way, the disclosed technology improves balancing effectiveness, enhances fault detection, supports safer operation of high-voltage battery installations, and promotes more reliable long-term use in containerized battery energy storage applications.

Further features and advantages of the disclosure, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Together with the following detailed descriptions, the accompanying drawings illustrate a number of exemplary embodiments in addition to describing and demonstrating various aspects and/or principles set forth in the present disclosure. The accompanying drawings and the brief descriptions are provided to enable one of ordinary skill in the art to practice the various aspects and/or principles set forth in the present disclosure.

FIG. 1 illustrates an example containerized BESS DC block having high-voltage battery modules or battery packs according to an embodiment of the present invention.

FIG. 2 illustrates an example of a BESS DC block having high-voltage battery modules or battery packs with container doors removed according to an embodiment of the present invention.

FIG. 3 illustrates an arrangement of high-voltage battery modules or battery packs in an example containerized BESS DC block according to an embodiment of the present invention.

FIG. 4 illustrates an example high-voltage battery module or battery pack according to an embodiment of the present invention.

FIG. 5 illustrates an exploded view of an example battery module or battery pack according to an embodiment of the present invention.

FIG. 6 illustrates an example battery module controller and example connectors that may be used with battery modules and battery packs according to embodiments of the present invention.

FIG. 7 illustrates an example battery module controller according to an embodiment of the present invention.

FIG. 8 illustrates an example battery module controller according to an embodiment of the present invention.

FIG. 9A illustrates an example battery module controller according to an embodiment of the present invention.

FIG. 9B illustrates an example power supply for a battery module controller according to an embodiment of the present invention.

FIG. 10 (separated into partial views shown in FIGS. 10A-10Q) illustrates an example battery module controller according to an embodiment of the present invention.

FIG. 11 (separated into partial views shown in FIGS. 11A-11D) illustrates an example power supply of a battery module controller according to an embodiment of the present invention.

FIG. 12 illustrates an example connector for a battery module controller according to an embodiment of the present invention.

FIG. 13 illustrates an example battery module controller graphical user interface according to an embodiment of the present invention.

FIGS. 14A-B illustrate an example battery rack controller according to an embodiment of the present invention.

FIG. 15 illustrates an example battery management system software architecture according to an embodiment of the present invention.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

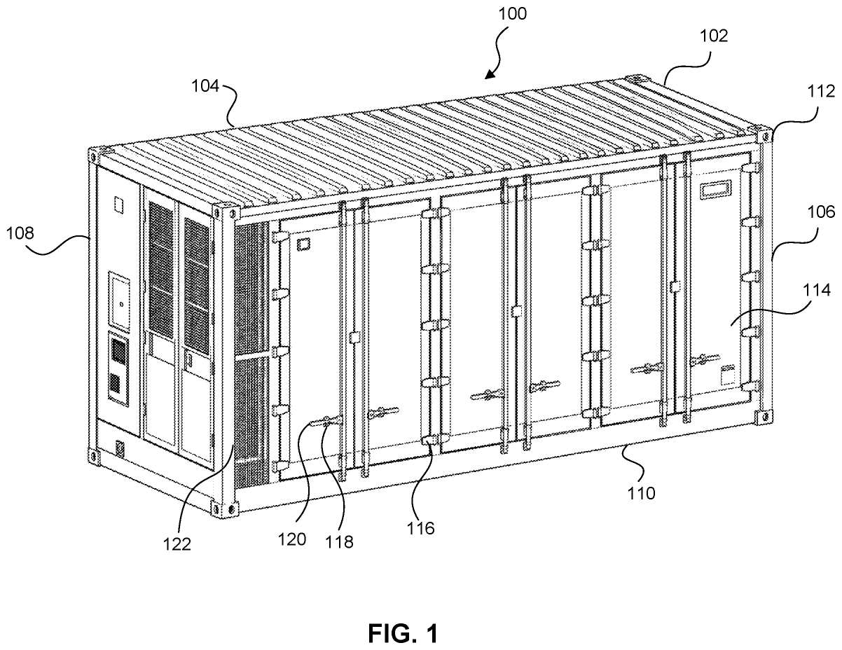

FIG. 1 illustrates an example containerized BESS DC block 100 having high-voltage battery modules or battery packs according to an embodiment of the present invention. BESS DC block 100 may include a transportable container housing 102 configured to receive and protect a plurality of high-voltage battery modules, battery packs, battery racks, power distribution components, cooling components, monitoring electronics, and safety control circuitry.

In the illustrated embodiment, the container housing 102 has a generally rectangular shipping-container-style structure including a roof 104, side walls 106, end walls 108, a base frame 110, and corner support or lifting structures 112. The roof 104 may include corrugations, reinforcing ribs, or other structural members that provide mechanical stiffness and environmental protection. The corrugations may be oriented longitudinally or transversely to provide optimal structural strength and water drainage. In some embodiments, the roof 104 may include integrated mounting points for solar panels, communication antennas, weather monitoring equipment, or auxiliary power systems. Roof 104 may further incorporate thermal insulation materials, reflective coatings, or heat-dissipating surfaces to minimize thermal loading on the internal battery systems.

The base frame 110 and corner structures 112 may allow the BESS DC block 100 to be transported, lifted, mounted, or installed as a modular DC energy storage block. Corner support structures 112 may be configured to standard ISO shipping container specifications, enabling BESS DC block 100 to be handled by standard container handling equipment, including cranes, forklifts, reach stackers, and container chassis. Base frame 110 may include integrated tie-down points, lifting lugs, forklift pockets, twist locks, or other securing mechanisms that can facilitate transportation by truck, rail, or ship. In some embodiments, base frame 110 may include adjustable leveling feet, vibration isolation mounts, or seismic restraint systems to ensure stable installation and operation in various site conditions.

Side walls 106 and end walls 108 may be constructed from steel, aluminum, composite materials, or other suitable structural materials that can provide mechanical protection, electromagnetic shielding, fire resistance, and environmental sealing. The walls may incorporate insulation layers, vapor barriers, or thermal management features to maintain optimal operating temperatures for the internal battery systems. In some embodiments, the walls may include integrated cable management systems, conduit pathways, or service access panels that can facilitate field installation and maintenance.

The containerized BESS DC block 100 may include a plurality of exterior access doors 114 positioned along one or more side walls of the container housing 102. The access doors 114 may provide service access to internal battery modules, battery packs, battery racks, coolant connections, electrical disconnects, contactors, fuses, sensors, busbars, battery management system components, or other internal equipment. Each access door 114 may include hinges 116, locking latches 118, handles 120, gaskets, seals, or other closure features configured to permit maintenance access while protecting the internal battery components from environmental exposure.

In some embodiments, exterior access doors 114 may be configured as single doors, double doors, sliding doors, roll-up doors, or removable panels depending on the size and accessibility requirements of the internal equipment. The doors may incorporate viewing windows, status indicator panels, emergency access features, or integrated tool storage compartments. Locking latches 118 may include keyed locks, combination locks, electronic locks, or tamper-evident sealing mechanisms to provide security and access control. In some installations, exterior access doors 114 may be equipped with door position sensors, interlock switches, or automatic closing mechanisms that can integrate with the battery management system to ensure safe operation during maintenance activities.

Hinges 116 may be constructed from corrosion-resistant materials and may include features such as removable pins, adjustable positioning, or heavy-duty load ratings to accommodate repeated opening and closing cycles under various environmental conditions. Handles 120 may be ergonomically designed and may include features such as integrated locks, emergency release mechanisms, or tool-free operation to facilitate safe and efficient maintenance access.

In some embodiments, the container housing 102 may further include one or more ventilation panels, grille panels, screened openings, or cooling-air access regions 122. The ventilation or grille regions 122 may be positioned adjacent to an equipment compartment, thermal management compartment, battery compartment, or auxiliary electrical compartment. The ventilation regions 122 may allow air intake, air exhaust, heat rejection, pressure relief, or access to cooling equipment associated with the BESS DC block 100. Ventilation regions 122 may incorporate weather-resistant louvers, bird guards, insect screens, or filtration systems to prevent contamination while maintaining adequate airflow. In some embodiments, the ventilation regions may include motorized dampers, variable-speed fans, or automated control systems that can adjust airflow based on internal temperature, humidity, or battery operating conditions. The cooling system may utilize ambient air cooling, forced air cooling, liquid cooling, refrigeration, or hybrid cooling approaches depending on the climate conditions and performance requirements of the installation.

The BESS DC block 100 may also include one or more external service panels, status displays, electrical access panels, communication ports, emergency stop devices, manual disconnects, grounding points, or identification panels. Such components may be positioned on an end wall or side wall of the container housing 102 to allow field connection, commissioning, maintenance, or emergency service without requiring removal of the battery modules or battery packs. For example, the external service panels may include high-voltage DC terminals, AC power connections, control signal interfaces, fiber optic communication ports, Ethernet connections, or wireless communication antennas. Status displays may provide real-time information about system voltage, current, power, energy, temperature, fault conditions, or operational status. Emergency stop devices may include large, easily accessible buttons or switches that can immediately disconnect BESS DC block 100 from external systems in case of an emergency.

The high-voltage battery modules or battery packs may be arranged within the container housing 102 in one or more rows, racks, stacks, trays, or compartments. In some embodiments, the battery modules or packs may be connected in series, parallel, or series-parallel arrangements to form a high-voltage DC energy storage block. The DC block 100 may provide a DC output to an inverter, power conversion system, DC combiner, switchgear, charger, microgrid controller, or other external electrical system. In some embodiments, BESS DC block 100 may contain between 20 and 100 individual battery packs, each rated at 50 kWh to 200 kWh, resulting in a total energy capacity ranging from 1 MWh to 10 MWh or more. The DC voltage of the system may range from 400V to 1500V, with current capabilities ranging from hundreds to thousands of amperes. The modular arrangement may allow for scalable energy storage solutions that can be customized to meet specific application requirements.

In one embodiment, the containerized BESS DC block 100 includes integrated battery monitoring, safety disconnect, cooling, fire detection, gas detection, pressure relief, current sensing, voltage sensing, insulation monitoring, and communication functions. The DC block 100 may communicate with an external system controller, inverter controller, battery management system, or site energy management system to provide operating data, fault data, state-of-charge information, state-of-health information, temperature information, and safety status.

In one embodiment, containerized BESS DC block 100 may include integrated battery monitoring, safety disconnect, cooling, fire detection, gas detection, pressure relief, current sensing, voltage sensing, insulation monitoring, and communication functions. DC block 100 may communicate with an external system controller, inverter controller, battery management system, or site energy management system to provide operating data, fault data, state-of-charge information, state-of-health information, temperature information, and safety status.

The integrated monitoring systems may include individual cell voltage monitoring, pack voltage monitoring, current sensing at multiple levels, temperature monitoring at cell, pack, and ambient levels, humidity monitoring, gas detection for early fire warning, and mechanical stress monitoring to detect cell swelling or other physical changes. The safety systems may include automatic fire suppression, emergency ventilation, electrical isolation, and communication with external emergency response systems.

The fire detection system may utilize smoke detectors, heat detectors, gas sensors, or thermal imaging cameras to provide early warning of thermal runaway or other hazardous conditions. The fire suppression system may employ water mist, inert gas, foam, or other appropriate suppression agents depending on the battery chemistry and installation requirements. Gas detection systems may monitor for hydrogen, carbon monoxide, or other gases that may be produced during battery operation or failure conditions.

In an alternative embodiment, BESS DC block 100 may be configured as a mobile or transportable energy storage system. In this configuration, container housing 102 may include additional features such as integrated wheels, trailer hitches, stabilizing jacks, or self-contained power systems that can allow the unit to be rapidly deployed for temporary power applications, emergency response, or grid support services. The mobile configuration may include satellite communication systems, GPS tracking, remote monitoring capabilities, and autonomous operation features that can enable unmanned deployment and operation.

The mobile BESS DC block may be equipped with rapid connection systems that can allow quick coupling to local electrical infrastructure, temporary power distribution systems, or other mobile power units. The system may include automated setup and commissioning features that can minimize the time and expertise required for deployment. In emergency response applications, the mobile BESS may provide backup power for critical facilities, support disaster relief operations, or provide grid stabilization services during power system restoration.

In another alternative embodiment, BESS DC block 100 may be configured for marine applications, including shipboard installation, offshore platforms, or floating energy storage systems. In this configuration, container housing 102 may include additional features such as corrosion-resistant coatings, enhanced sealing systems, vibration isolation, motion compensation systems, and compliance with marine safety standards. The marine configuration may include integrated ballast systems, dynamic positioning interfaces, or connection systems for floating solar or wind power generation systems.

The configuration shown in FIG. 1 is illustrative and is not intended to limit the invention to the particular number, shape, location, or arrangement of doors, panels, vents, latches, compartments, or structural features shown. In other embodiments, the BESS DC block 100 may have different container sizes, different access door arrangements, different cooling configurations, different battery module layouts, or different service panel locations while still providing a modular containerized high-voltage DC battery block.

For instance, smaller containerized systems may utilize 10-foot or 20-foot container formats, while larger systems may employ 45-foot or 53-foot containers, or custom-sized enclosures. The container may be configured for indoor installation, outdoor installation, underground installation, or elevated installation depending on site requirements and local regulations. The system may be designed for permanent installation or for temporary deployment, with corresponding differences in foundation requirements, utility connections, and maintenance access provisions.

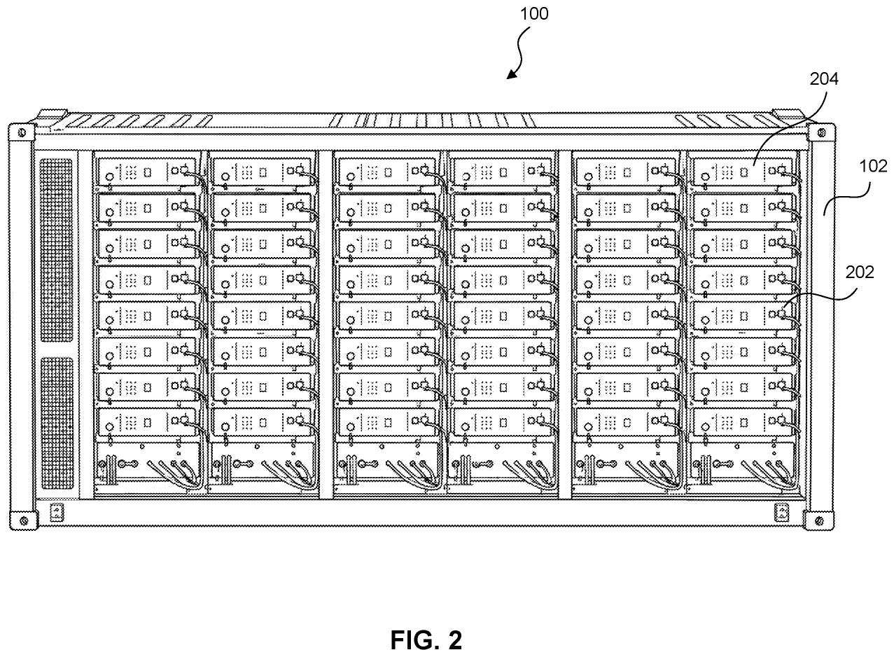

FIG. 2 further illustrates the containerized BESS DC block 100 of FIG. 1 with one or more exterior access doors removed or opened to expose a plurality of high-voltage battery packs 202 according to an embodiment of the present invention. In the illustrated embodiment, the battery packs 202 are arranged within the container housing 102 in a plurality of rack sections, bays, shelves, trays, or vertical compartments 204. Each compartment 204 may support a stack of battery packs 202 positioned one above another to form a high-voltage battery rack or subassembly.

Each battery pack 202 may include a plurality of electrochemical cells connected in series, parallel, or a series-parallel configuration. In some embodiments, each battery pack 202 may include a front-facing pack enclosure, electrical terminals, sense connections, coolant connections, communication connections, a manual service disconnect, fusing, contactors, balancing circuitry, temperature sensors, pressure or strain sensors, and a pack-level battery management circuit.

As shown in FIG. 2, the battery packs 202 may be accessible from a service side of the containerized DC block 100. The front-facing arrangement allows an operator or service technician to inspect, connect, disconnect, replace, or service individual battery packs 202 without removing the entire containerized DC block 100 from service. The battery packs 202 may be mechanically supported by internal rails, shelves, brackets, or rack frames that maintain pack alignment and provide structural support during operation, transportation, installation, and maintenance.

In one embodiment, each compartment 204 may house between 8 and 16 high-voltage battery packs 202, with a typical configuration that may include 8 high-voltage battery packs per vertical stack. For example, in a 5 MWh containerized BESS DC block configuration, the system may include six compartments 204, each containing 8 high-voltage battery packs 202 of approximately 100 kWh capacity each, which may result in a total of 48 high-voltage battery packs providing 4.8 MWh of energy storage. Alternative configurations may include compartments with 10, 12, 14, or 16 high-voltage battery packs depending on the desired energy density, voltage requirements, and thermal management considerations.

The battery packs 202 may be electrically interconnected by cables, busbars, harnesses, connectors, or other conductive members 208 to form one or more high-voltage DC strings. In some embodiments, multiple stacks or rack sections may be connected in series, parallel, or series-parallel arrangements to provide a desired DC voltage, current capability, and energy capacity. Lower portions of one or more rack sections may include distribution, sensing, control, protection, or interconnection regions 210 for routing high-voltage conductors, communication wiring, coolant lines, grounding conductors, or auxiliary power connections.

Lower portions of one or more rack sections may include distribution, sensing, control, protection, or interconnection regions 210 for routing high-voltage conductors, communication wiring, coolant lines, grounding conductors, or auxiliary power connections. These regions 210 may house DC contactors that may be rated for 1000 A or higher, high-voltage fuses that may be rated for the maximum fault current of the system, current sensors that may be capable of measuring DC currents up to 2000 A with high accuracy, and voltage sensors for monitoring the DC bus voltage.

The interconnection region 210 may also include a rack-level battery management system controller that may communicate with individual battery module controllers 640 within each battery pack 202. This rack-level controller may aggregate data from all high-voltage battery packs within the compartment, which may include cell voltages, temperatures, pressure measurements, balancing status, and fault conditions. The rack-level controller may implement safety functions such as emergency shutdown, overcurrent protection, overvoltage protection, undervoltage protection, and thermal protection for the entire rack section.

In a specific embodiment, each battery pack 202 may contain 280 individual lithium-ion cells that may be arranged in a 280s1p configuration (280 cells in series, 1 parallel string). Using cells with a nominal voltage of 3.6V, each high-voltage battery pack could provide approximately 1008V nominal voltage. The cells may be cylindrical 21700 format cells with individual capacities of 5 Ah, which may provide each high-voltage battery pack with approximately 5 kWh of energy storage. Twenty such high-voltage battery packs connected in parallel could provide 100 kWh of energy storage at 1008V nominal voltage.

The containerized DC block 100 may also include one or more ventilation, cooling, or thermal management regions positioned adjacent to the battery pack compartments. The thermal management regions may include air filters, grilles, fans, heat exchangers, coolant manifolds, liquid cooling connections, ducting, or other components configured to maintain the battery packs 202 within a desired operating temperature range.

The liquid cooling system may circulate a dielectric coolant fluid such as propylene glycol or a specialized battery coolant through cooling plates that may be integrated within each battery pack 202. The coolant may be circulated at flow rates of 2-5 liters per minute per battery pack, with supply temperatures that may be maintained between 20 °C and 25 °C. Quick-disconnect coolant fittings on each battery pack 202 may allow for rapid connection and disconnection during maintenance operations while minimizing coolant spillage.

In one embodiment, each battery pack 202 may be independently monitored by a pack-level battery management system and may communicate pack voltage, cell voltage, temperature, current, state of charge, state of health, balancing status, service disconnect status, and fault information to a rack-level or container-level controller. The container-level controller may aggregate information from the battery packs 202 and control contactors, relays, cooling equipment, safety disconnects, fire detection systems, or external communications for the BESS DC block 100.

The container-level controller may aggregate information from the high-voltage battery packs 202 and control contactors, relays, cooling equipment, safety disconnects, fire detection systems, or external communications for the containerized BESS DC block 100. This master controller may implement system-level functions that may include state-of-charge balancing between high-voltage battery packs, thermal management optimization, predictive maintenance scheduling, and communication with external energy management systems or grid operators.

Each battery pack 202 may include advanced safety features such as pyrotechnic disconnects that can physically separate the pack from the DC bus in case of thermal runaway or other emergency conditions. Gas detection sensors within each pack may monitor for hydrogen fluoride, carbon monoxide, or other toxic gases that may be released during cell failure. Pressure relief vents may be designed to direct any vented gases away from personnel areas and toward dedicated exhaust systems.

The arrangement shown in FIG. 2 provides a modular serviceable architecture in which individual battery packs 202 may be installed, removed, replaced, isolated, tested, or maintained at the pack level. This modular arrangement may improve manufacturability, field serviceability, fault isolation, transportation, scalability, and safety of the containerized BESS DC block 100.

In an alternative embodiment, the containerized BESS DC block 100 may be configured with distributed battery management architecture where each battery pack 202 may include not only local monitoring and control capabilities but also autonomous decision-making functions. In this configuration, each high-voltage battery pack may independently determine its own charging and discharging limits based on local conditions such as temperature, state of charge, and cell balance, while communicating these limits to a central coordinator that may optimize overall system performance.

The distributed architecture may include peer-to-peer communication between adjacent high-voltage battery packs 202, which may allow for rapid fault propagation and coordinated emergency responses. For instance, if one high-voltage battery pack detects the onset of thermal runaway, it can immediately signal adjacent packs to reduce their current output and prepare for potential isolation, while simultaneously notifying the container-level controller to initiate emergency cooling and ventilation procedures.

Another alternative embodiment may incorporate wireless communication capabilities within each battery pack 202, which may eliminate the need for physical communication harnesses between packs and the rack-level controller. This wireless approach may use industrial-grade protocols such as WirelessHART or proprietary mesh networking to ensure reliable data transmission even in the electromagnetically noisy environment of a high-power battery system.

The wireless communication system may include redundant communication paths and automatic failover mechanisms to maintain system monitoring and control capabilities even if individual communication nodes fail. High-voltage battery packs may be equipped with backup power sources to maintain communication capabilities during system shutdown or emergency conditions.

In yet another embodiment, the containerized BESS DC block 100 may incorporate artificial intelligence and machine learning capabilities at both the pack level and system level. Each battery module controller 640 may include processing capabilities to analyze local battery performance trends, predict maintenance needs, and optimize balancing strategies based on historical usage patterns and environmental conditions.

The AI-enabled system may continuously learn from operational data to improve performance predictions, extend battery life, and prevent failures before they occur. Machine learning algorithms may analyze patterns in cell voltage, temperature, and mechanical stress data to identify early indicators of cell degradation or potential safety issues.

The configuration shown in FIG. 2 is illustrative and is not intended to limit the invention to any particular number of battery packs, rack sections, shelves, compartments, cables, cooling regions, or pack orientations. In other embodiments, the BESS DC block 100 may include different pack quantities, different rack layouts, different electrical interconnection schemes, different cooling configurations, or different access arrangements while still providing a containerized high-voltage battery DC block.

The system may also be scaled to different energy capacities by varying the number and capacity of individual high-voltage battery packs 202. Smaller installations may use 50 kWh high-voltage battery packs to create 1-2 MWh systems, while larger installations may use 150 kWh or 200 kWh high-voltage battery packs to create 10 MWh or larger systems. The modular architecture may allow for easy scaling and customization to meet specific application requirements while maintaining standardized interfaces and control systems.

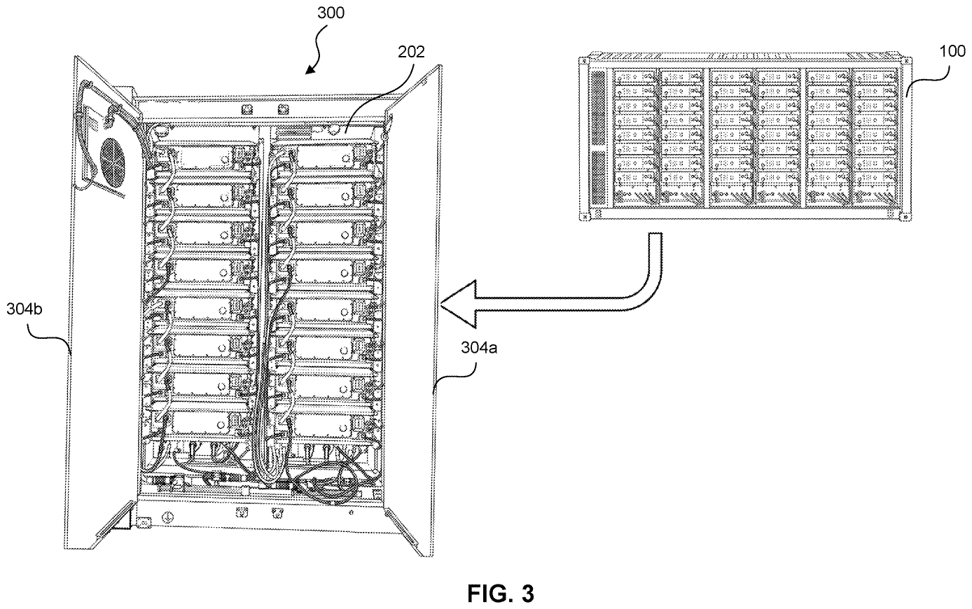

FIG. 3 illustrates an example section 300 of the containerized BESS DC block 100 according to an embodiment of the present invention. As shown, the section 300 may be one rack section, bay, compartment, cabinet, or service-access region of the larger BESS DC block 100. The section 300 may be configured to house a plurality of high-voltage battery packs 202 that are mechanically supported, electrically interconnected, thermally managed, monitored, and serviced as a modular subassembly of the BESS DC block 100.

In the illustrated embodiment, the section 300 includes sixteen high-voltage battery packs 202. The battery packs 202 may be arranged in two vertical stacks, with each stack including eight battery packs 202 positioned one above another. In other embodiments, the number of battery packs, the number of stacks, and the orientation of the battery packs may vary depending on the desired voltage, current capability, energy capacity, container size, service requirements, or thermal management arrangement.

Each battery pack 202 may include a pack enclosure, a plurality of electrochemical cells, internal electrical conductors, one or more battery management circuits, cell voltage sensing connections, temperature sensors, current sensing components, fuses, manual service disconnects, coolant quick-disconnect fittings, communication connectors, and high-voltage positive and negative terminals. The battery packs 202 may be electrically connected in series, parallel, or series-parallel configurations to form a high-voltage DC string or portion of a high-voltage DC string within the BESS DC block 100.

In some embodiments, the battery packs 202 within section 300 may be connected in a series configuration to achieve a high DC voltage, such as 800V, 1000V, 1200V, or 1500V DC. For instance, if each battery pack 202 provides approximately 100V DC, then eight battery packs connected in series may provide approximately 800V DC per stack. The two stacks may then be connected in parallel to double the current capacity while maintaining the 800V DC voltage level. This series-parallel arrangement may allow section 300 to provide both high voltage and high current capability suitable for multi-megawatt energy storage applications.

The section 300 may include a rack frame, cabinet frame, rails, shelves, brackets, or other mechanical support structure configured to support the battery packs 202 during shipping, installation, operation, and maintenance. The support structure may maintain spacing between adjacent battery packs 202 to provide clearance for wiring, cooling, airflow, service access, or thermal isolation. The support structure may be constructed from steel, aluminum, or composite materials and may include reinforcing members, cross-braces, or structural supports that may be designed to withstand the weight of the battery packs 202 and any dynamic loads encountered during operation or transportation. The frame may also include grounding connections, bonding straps, or electrical continuity features that may ensure proper electrical safety and electromagnetic compatibility.

As shown in FIG. 3, the section 300 may include a service opening or access door 304. The access door 304 may be hinged, removable, sealed, gasketed, lockable, or otherwise configured to permit access to the battery packs 202 while protecting the battery packs from environmental exposure during normal operation. The access door 304 may allow a technician to inspect, disconnect, remove, replace, or service one or more battery packs 202 without removing the entire BESS DC block 100 from service.

In some embodiments, the access door 304 may include multiple panels, sections, or sub-doors that may provide selective access to different portions of section 300. For example, the access door 304 may include upper and lower panels that can be independently opened to access different vertical regions of the battery pack stacks. This selective access capability may improve safety by allowing technicians to isolate and service specific battery packs while keeping other packs energized and operational. The access door 304 may further include safety interlocks, position sensors, or status indicators that may communicate door position to the battery management system. When the access door 304 is opened, the system may automatically disable high-voltage circuits, activate warning lights, initiate ventilation systems, or implement other safety protocols to protect service personnel.

The section 300 may further include wiring, cabling, busbars, harnesses, coolant lines, communication wiring, and auxiliary power wiring routed along one or more side portions, rear portions, lower portions, or central portions of the section 300. Such conductors or fluid lines may interconnect the battery packs 202 with a rack-level controller, pack-level BMS circuits, contactors, fuses, current sensors, coolant manifolds, or a container-level DC bus.

In some embodiments, section 300 may include a high-voltage DC busbar system that may interconnect the positive and negative terminals of the battery packs 202. The busbar system may include copper or aluminum conductors that may be sized to carry the full rated current of the section 300, which may be several hundred amperes or more. The busbars may include insulation, protective covers, or barriers that may prevent accidental contact and may be color-coded or labeled to indicate polarity and voltage levels.

The section 300 may also include a low-voltage wiring harness that may provide communication, control, and auxiliary power connections to each battery pack 202. This harness may carry CAN bus signals, discrete control signals, temperature sensor wiring, pressure sensor wiring, balancing control signals, and low-voltage DC power for pack-level electronics. The low-voltage harness may be routed separately from high-voltage conductors to minimize electromagnetic interference and improve safety.

For thermal management, section 300 may include a coolant distribution system with supply and return manifolds, coolant hoses, quick-disconnect fittings, flow sensors, temperature sensors, and pressure sensors. The coolant system may circulate a dielectric fluid, such as a glycol-water mixture, through cooling passages within each battery pack 202 to maintain optimal operating temperatures. In some embodiments, the coolant system may include individual flow control valves for each battery pack 202, which may allow independent thermal management of each pack based on its specific thermal load and operating conditions.

In some embodiments, each section 300 may operate as a modular battery rack or modular battery bay. A plurality of sections 300 may be installed within the containerized BESS DC block 100 to achieve a desired total energy capacity. Each section 300 may be individually monitored, isolated, disconnected, replaced, or serviced. This modular arrangement may improve scalability, manufacturability, transportation, maintenance, and fault isolation.

For example, a 5 MWh containerized BESS DC block 100 may include multiple sections 300, each providing approximately 1.6 MWh of energy storage capacity. If each battery pack 202 in section 300 provides 100 kWh of energy capacity, then the sixteen packs in section 300 may provide a total of 1.6 MWh. Three such sections 300 may provide approximately 4.8 MWh, with additional sections or partial sections that may be added to reach the target 5 MWh capacity.

The modular design of section 300 may also facilitate staged commissioning and incremental capacity expansion. During initial installation, a subset of sections 300 may be installed and commissioned, with additional sections that may be added later as energy storage requirements grow. This approach may reduce initial capital investment and may allow the energy storage system to scale with demand.

Section 300 may further include safety and monitoring equipment such as smoke detectors, gas detectors, temperature sensors, humidity sensors, fire suppression nozzles, emergency lighting, communication equipment, and local control panels. These safety systems may be integrated with the container-level safety system and may provide local monitoring, alarming, and emergency response capabilities specific to section 300.

In some embodiments, section 300 may include a rack-level battery management controller that may aggregate data from the individual battery pack controllers and may communicate with the container-level battery management system. The rack-level controller may monitor the overall performance of section 300, coordinate balancing operations across multiple battery packs 202, manage thermal control systems, and implement safety shutdown procedures when necessary.

The rack-level controller may also implement load balancing algorithms that may distribute charge and discharge currents among the battery packs 202 in section 300 to optimize performance and extend service life. For example, the controller may preferentially charge or discharge battery packs with lower state-of-charge values to maintain balance across the section 300.

The arrow shown in FIG. 3 indicates that the section 300 may be a selected portion of the larger containerized BESS DC block 100. Accordingly, the BESS DC block 100 may include multiple similar sections 300, each containing a plurality of high-voltage battery packs 202. The arrangement shown in FIG. 3 is illustrative and is not intended to limit the invention to exactly sixteen battery packs, two vertical stacks, or the particular mechanical configuration shown. In other embodiments, the section 300 may include more or fewer battery packs, different pack orientations, different cooling arrangements, different electrical interconnection schemes, or different service access structures while still functioning as a modular high-voltage battery section of the BESS DC block 100.

In an alternative embodiment, section 300 may be configured as a mobile or transportable battery module that can be removed from the containerized BESS DC block 100 for off-site maintenance, refurbishment, or redeployment. In this configuration, section 300 may include integrated lifting points, transportation brackets, environmental protection features, and self-contained monitoring systems that may allow it to operate independently during transportation and temporary deployment.

The section 300 may also be designed with redundant systems that may improve reliability and availability. For example, section 300 may include redundant communication paths, backup power supplies for control systems, redundant cooling circuits, and redundant safety systems. If one system fails, the redundant system may maintain operation of section 300 until repairs can be made.

In some embodiments, section 300 may include energy storage technologies other than or in addition to electrochemical batteries. For example, section 300 may include supercapacitors, flywheels, compressed air energy storage components, or hybrid energy storage systems that may combine multiple technologies to optimize performance for specific applications.

The configuration shown in FIG. 3 may also enable advanced diagnostic and prognostic capabilities. Each battery pack 202 within section 300 may continuously monitor its own health and performance, while the rack-level controller may analyze trends and patterns across all packs in the section. This data may be used to predict maintenance requirements, optimize operating parameters, and schedule preventive maintenance activities.

Furthermore, section 300 may be equipped with wireless communication capabilities that may allow remote monitoring and control. Technicians may access real-time data from section 300 using mobile devices, tablets, or laptop computers, which may enable remote diagnostics and may reduce the need for on-site visits.

The arrangement shown in FIG. 3 is illustrative and is not intended to limit the invention to exactly sixteen battery packs, two vertical stacks, or the particular mechanical configuration shown. In other embodiments, the section 300 may include more or fewer battery packs, different pack orientations, different cooling arrangements, different electrical interconnection schemes, or different service access structures while still functioning as a modular high-voltage battery section of the BESS DC block 100. For instance, section 300 could be configured with horizontal battery pack orientations, diagonal arrangements, or circular configurations depending on the specific requirements of the application and the available space within the containerized BESS DC block 100.

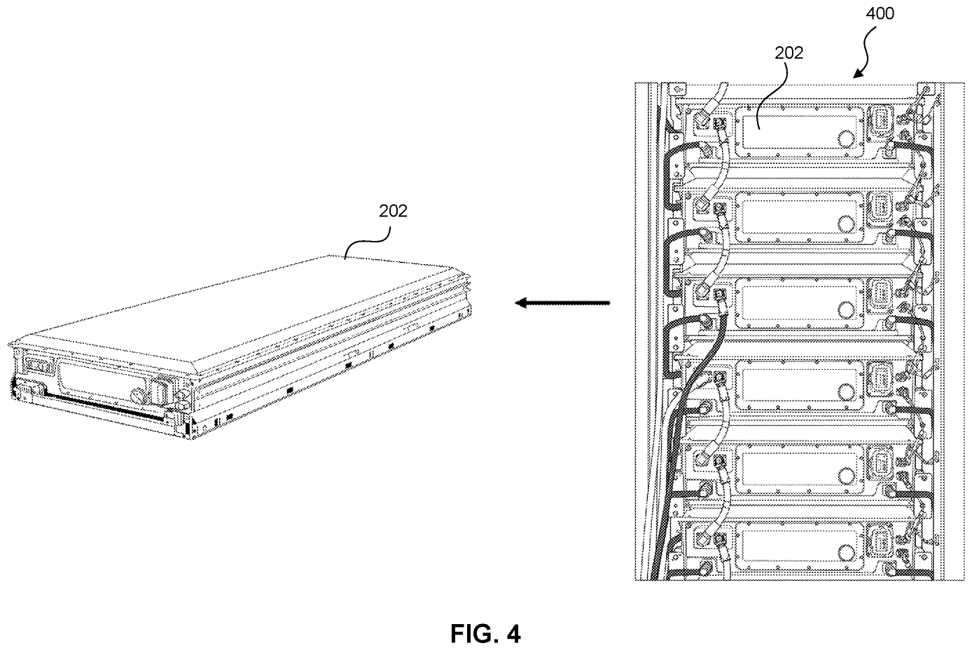

FIG. 4 illustrates an example section 400 of the BESS DC block 100 having a plurality of high-voltage battery packs 202 according to an embodiment of the present invention. The section 400 may correspond to a rack, bay, cabinet, compartment, or service-access portion of the containerized BESS DC block 100. The section 400 may be configured to receive, support, electrically interconnect, cool, monitor, and permit service access to a plurality of battery packs 202.

As shown in FIG. 4, each battery pack 202 may have a generally rectangular, slide-in enclosure configured to be inserted into or removed from the section 400. The battery pack 202 may include a front-facing service end having one or more electrical connectors, high-voltage terminals, communication connectors, coolant fittings, manual service disconnects, indicators, handles, fasteners, or locking features. The battery pack 202 may be sized and shaped to be mounted in a horizontal orientation within a corresponding rack position of the section 400.

In some embodiments, each battery pack 202 may have standardized dimensions to ensure compatibility across different BESS installations. For example, battery pack 202 may conform to a 19-inch rack-mount standard, a 23-inch telecommunications rack standard, or a custom modular dimension that may be optimized for containerized energy storage applications. The standardized form factor may facilitate manufacturing economies of scale, interchangeability between different BESS projects, simplified logistics, and reduced spare parts inventory requirements.

Battery pack 202 may include an integrated structural frame, chassis, or enclosure that may provide mechanical protection for internal electrochemical cells while maintaining electrical isolation and environmental sealing. The enclosure may be constructed from aluminum, steel, composite materials, or engineered plastics that may be selected for strength, weight, corrosion resistance, thermal conductivity, electrical insulation properties, and fire resistance. In some embodiments, the enclosure may include reinforcing ribs, impact-resistant corners, vibration-dampening features, or shock-absorbing elements that may protect the internal cells during transportation, installation, and operation.

The section 400 may include a plurality of vertically arranged pack positions, slots, shelves, rails, or support members. Each pack position may receive a corresponding battery pack 202. In the illustrated embodiment, several battery packs 202 are stacked one above another within the section 400. The battery packs 202 may be individually removable from the section 400 for installation, inspection, replacement, repair, testing, or decommissioning.

In a specific example embodiment, section 400 may accommodate eight battery packs 202 that may be arranged in a single vertical column, with each pack position providing approximately 100 kWh of energy storage capacity. This configuration may yield approximately 800 kWh of total energy storage per section 400. In alternative embodiments, section 400 may accommodate different quantities of battery packs, such as six packs, ten packs, twelve packs, or sixteen packs, depending on the desired energy density, voltage requirements, current capability, thermal management constraints, and service accessibility requirements.

Section 400 may include guide rails, alignment channels, support brackets, or positioning features that may facilitate precise insertion and removal of each battery pack 202. The guide rails may be constructed from steel, aluminum, or engineered polymer materials and may include low-friction surfaces, roller elements, ball-bearing slides, or linear bearing systems that may reduce insertion and extraction forces. In some embodiments, the guide rails may include positive stops, detents, or locking mechanisms that may secure each battery pack 202 in its installed position and may prevent inadvertent movement during operation or transportation.

The arrow shown in FIG. 4 indicates that an individual battery pack 202 may be inserted into or removed from the section 400 through a front service opening. This arrangement permits pack-level service access without requiring removal of the entire BESS DC block 100 or disassembly of the surrounding container structure. In some embodiments, the battery pack 202 may slide along guide rails, support channels, shelves, or brackets that align the battery pack 202 with corresponding electrical, mechanical, coolant, and communication interfaces within the section 400.

The front-service architecture may significantly reduce maintenance time and labor costs compared to systems that may require rear access, overhead access, or complete system shutdown for individual pack replacement. For example, a trained technician may be able to replace a faulty battery pack 202 in less than 30 minutes, compared to several hours that may be required for systems with less accessible architectures. This improved serviceability may increase system availability, reduce operational costs, and minimize revenue losses that may be associated with extended maintenance outages.

Each battery pack 202 may include a plurality of electrochemical cells connected in series, parallel, or series-parallel configuration. Each battery pack 202 may further include internal busbars, fuses, contactors, current sensors, voltage sensing circuits, temperature sensors, pressure sensors, strain sensors, coolant passages, cell balancing circuits, and a pack-level battery management system. The pack-level battery management system may monitor the condition of cells within the battery pack 202 and communicate pack status information to a rack-level, section-level, or container-level controller. In one specific embodiment, each battery pack 202 may contain 280 cylindrical lithium-ion cells that may be arranged in a 14-series, 20-parallel configuration (14S20P). Each cell may have a nominal voltage of 3.6V and a capacity of 5.0 Ah, which may result in a pack nominal voltage of approximately 50.4V and a capacity of approximately 100 Ah. This configuration may provide approximately 5.04 kWh of energy storage per pack. In alternative embodiments, battery pack 202 may use prismatic cells, pouch cells, or different cell chemistries such as lithium iron phosphate (LiFePO4), lithium nickel manganese cobalt oxide (NMC), or lithium titanate oxide (LTO).

The section 400 may include interconnection wiring, high-voltage conductors, busbars, communication harnesses, coolant hoses, coolant manifolds, auxiliary power wiring, and grounding conductors. These components may interconnect the battery packs 202 with other battery packs, a DC bus, a rack controller, a safety disconnect, a contactor assembly, a current sensor, a thermal management system, or a container-level battery management system.

In some embodiments, section 400 may include a main DC busbar system that may be rated for 1000V DC or higher, with individual battery packs 202 that may be connected in series to achieve the desired string voltage. For example, twenty battery packs 202 that may be connected in series may provide a string voltage of approximately 1008V DC (20×50.4V). The busbar system may include copper or aluminum conductors with appropriate insulation, spacing, and arc-fault protection that may ensure safe operation at high voltages.

Section 400 may include a rack-level controller or section-level controller that may communicate with the battery module controllers 640 of individual battery packs 202. The rack-level controller may aggregate data from multiple packs, coordinate balancing operations, manage thermal control systems, monitor string-level parameters, and communicate with higher-level controllers. The rack-level controller may implement safety functions such as string isolation, emergency shutdown, fire suppression activation, and fault reporting.

In some embodiments, the section 400 may include liquid-cooling connections arranged to mate with corresponding coolant fittings on each battery pack 202. The coolant connections may be configured as quick-disconnect fittings to allow removal and replacement of a battery pack 202 while reducing coolant leakage. In other embodiments, the section 400 may use air cooling, refrigerant cooling, conduction cooling, or a combination of cooling methods.

The liquid cooling system may circulate a dielectric coolant fluid, such as a glycol-water mixture, through cooling plates or channels within each battery pack 202. The coolant may be maintained at a temperature between 15 °C and 25 °C to optimize battery performance and longevity. The cooling system may include temperature sensors, flow sensors, pressure sensors, leak detection sensors, and automatic isolation valves that may ensure safe and reliable thermal management. In an air-cooled embodiment, section 400 may include forced-air circulation systems with intake filters, exhaust fans, ducting, and temperature control systems. The air cooling system may maintain battery pack temperatures within an optimal range while preventing the accumulation of dust, moisture, or contaminants that could affect battery performance or safety.

The section 400 may also include safety and diagnostic features. For example, the section 400 may include pack-present detection, service disconnect status detection, connector interlock circuits, insulation monitoring, fuse status monitoring, temperature monitoring, gas detection, pressure relief, or fault isolation circuitry. The section 400 may allow one battery pack 202 to be electrically isolated from other battery packs 202 in response to a fault or during service.

In some embodiments, section 400 may include gas detection sensors that may be configured to detect hydrogen, carbon monoxide, or other gases that may be released during battery cell failure or thermal runaway events. Upon detection of hazardous gases, section 400 may automatically isolate affected battery packs, activate ventilation systems, trigger fire suppression systems, and alert operators to the potential safety hazard.

Section 400 may include pressure relief systems that may be designed to safely vent gases and reduce pressure buildup in the event of battery cell failure. The pressure relief systems may include rupture discs, pressure relief valves, venting channels, or explosion-proof enclosures that may direct gases away from personnel and sensitive equipment.

The arrangement shown in FIG. 4 provides a modular and serviceable structure in which individual high-voltage battery packs 202 may be installed, removed, replaced, or isolated at the pack level. This modular design may improve assembly, shipping, maintenance, fault isolation, field replacement, scalability, and safety of the BESS DC block 100.

The modular architecture may also facilitate staged deployment and capacity expansion. For example, a BESS installation may initially be deployed with 50% of the available battery pack positions filled, with additional packs that may be added as energy storage requirements increase or as budget becomes available. This staged approach may reduce initial capital costs and may allow the system to grow with changing energy storage needs.

In an alternative embodiment, section 400 may be configured as a mobile or transportable battery rack that can be removed from the containerized BESS DC block 100 for off-site maintenance, refurbishment, or redeployment. The mobile rack may include integrated lifting points, transportation brackets, environmental protection, and self-contained cooling systems that may allow the entire section 400 to be transported as a unit while maintaining battery pack integrity and safety.

In another alternative embodiment, section 400 may include automated handling systems such as robotic pack insertion and removal mechanisms, automated connector engagement systems, or remote-controlled service equipment. These automated systems may reduce the need for personnel to work in close proximity to high-voltage equipment and may enable unmanned or remotely supervised maintenance operations.

Section 400 may also include advanced monitoring and diagnostic capabilities. For example, section 400 may include thermal imaging cameras, vibration sensors, acoustic monitoring systems, or optical inspection systems that may continuously monitor the condition of battery packs 202 and may detect early signs of degradation, damage, or failure. This predictive maintenance capability may allow proactive replacement of battery packs before failures occur, thereby improving system reliability and reducing unplanned downtime.

In some embodiments, section 400 may include integrated test and commissioning equipment that may allow individual battery packs 202 to be tested, calibrated, and verified before being placed into service. The test equipment may include programmable load banks, impedance analyzers, insulation testers, or automated test sequences that may verify pack performance, safety systems, and communication interfaces.

The configuration shown in FIG. 4 is illustrative and is not intended to limit the invention to the particular number, orientation, shape, or arrangement of battery packs 202 shown. In other embodiments, the section 400 may include more or fewer battery packs, different pack orientations, different connector locations, different cooling interfaces, different support structures, or different service access arrangements while still providing a modular battery pack section for a containerized BESS DC block.

For example, in a high-density configuration, section 400 may accommodate twelve or sixteen battery packs 202 in a 2×6 or 2×8 arrangement, with packs that may be accessible from both front and rear service openings. In a low-density configuration that may be optimized for enhanced cooling and service access, section 400 may accommodate only four or six battery packs 202 with increased spacing between packs.

Section 400 may be designed to accommodate different battery pack technologies and form factors as they become available. For example, section 400 may include adjustable mounting brackets, configurable electrical interfaces, and modular cooling connections that may allow future battery pack upgrades without requiring replacement of the entire section 400 infrastructure.

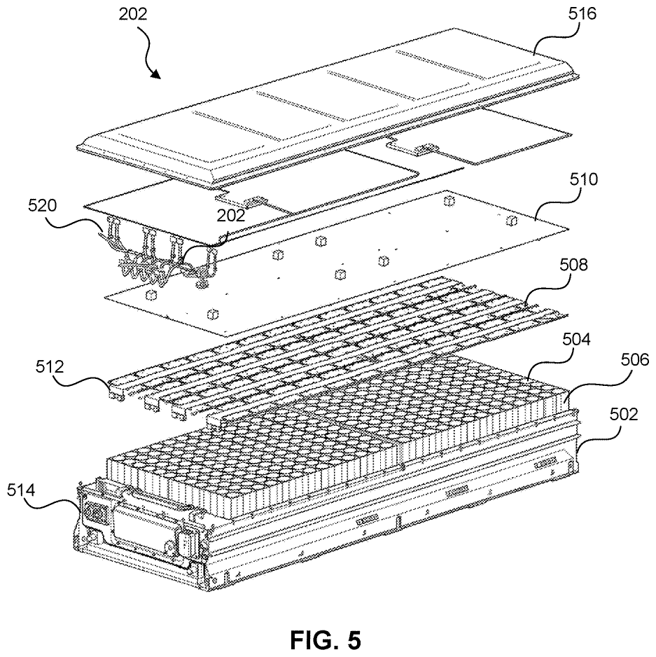

FIG. 5 illustrates an exploded view of an example battery pack 202 according to an embodiment of the present invention. The battery pack 202 may be configured for installation within a section of the BESS DC block 100, such as the section 300 of FIG. 3 or the section 400 of FIG. 4. The exploded view shows the battery pack 202 as including a plurality of stacked or layered components that cooperate to provide mechanical support, electrical interconnection, thermal management, sensing, protection, and serviceability.

In the illustrated embodiment, the battery pack 202 includes a lower housing or base tray 502 configured to receive and support a plurality of electrochemical cells 504. The cells 504 may be arranged in rows, columns, groups, or blocks within the base tray 502. The cells 504 may be cylindrical, prismatic, pouch, or other battery cell types, and may be connected in series, parallel, or series-parallel configuration to provide a desired pack voltage, energy capacity, and current capability.

Electrochemical cells 504 may be arranged in rows, columns, groups, or blocks within base tray 502. Electrochemical cells 504 may be cylindrical cells such as 18650, 21700, or 4680 format cells, prismatic cells, pouch cells, or other battery cell types. In one embodiment, battery pack 202 may include between 50 and 500 individual electrochemical cells 504, though other quantities are possible depending on the desired pack voltage, energy capacity, and current capability. Electrochemical cells 504 may be lithium-ion cells, lithium iron phosphate cells, nickel-metal hydride cells, or other electrochemical cell technologies suitable for energy storage applications.

Electrochemical cells 504 may be connected in series, parallel, or series-parallel configuration to provide a desired pack voltage, energy capacity, and current capability. For example, in one embodiment, battery pack 202 may include 96 cells arranged in a 96S1P configuration to provide approximately 350V nominal voltage and 100 kWh energy capacity. In another embodiment, battery pack 202 may include 192 cells arranged in a 48S4P configuration to provide approximately 175V nominal voltage with higher current capability. The specific cell arrangement may be selected based on system voltage requirements, current requirements, thermal management considerations, and safety requirements.

The battery pack 202 may further include one or more cell holders, spacers, frames, compression members, insulating layers, thermal interface layers, or structural support members 506 positioned adjacent to or above the cells 504.

Support members 506 may maintain cell spacing to ensure adequate airflow, prevent cell-to-cell contact, provide alignment during assembly, reduce vibration during transportation and operation, distribute compression forces evenly across the cell array, support busbars and interconnection hardware, or provide electrical insulation between cell terminals and other conductive portions of the pack. In some embodiments, support members 506 may include integrated cooling channels, thermal interface pads, vibration dampening materials, or compression springs that may maintain consistent contact pressure on electrochemical cells 504 throughout the operating temperature range.

An electrical interconnection layer 508 may be positioned above the cells 504. The electrical interconnection layer 508 may include busbars, conductive plates, current collectors, weld tabs, fuses, sense leads, cell voltage sensing conductors, temperature sensor conductors, balancing conductors, or other electrical connection features. The interconnection layer 508 may electrically couple selected cells 504 to form a high-voltage battery circuit and may provide connection points for a pack-level battery management system.

The busbars within electrical interconnection layer 508 may be constructed from copper, aluminum, or other conductive materials and may be sized to carry the full pack current without excessive voltage drop or heating. In one embodiment, the busbars may be configured to carry currents of 100A to 500A continuously, with short-term capability for higher currents during peak charge or discharge operations. The busbars may include integrated fusing, current sensing elements, or disconnect mechanisms that can provide overcurrent protection and isolation capability.

Electrical interconnection layer 508 may also include individual cell voltage sensing connections that may allow the battery module controller 640 to monitor the voltage of each electrochemical cell 504 independently. These sensing connections may be implemented using small-gauge wires, flexible circuits, or low-current busbars that connect to the positive and negative terminals of each electrochemical cell 504. The sensing connections may be electrically isolated from the high-current power connections to prevent interference and ensure accurate voltage measurements.

In some embodiments, electrical interconnection layer 508 may include cell-level fusing, where each electrochemical cell 504 or small group of cells may be protected by an individual fuse or current-limiting device. This arrangement may improve safety by preventing a single failed cell from affecting the entire battery pack 202. The cell-level fuses may be sized to interrupt current flow if a cell experiences thermal runaway, internal short circuit, or other failure modes.

The battery pack 202 may also include an intermediate plate, cover plate, insulation plate, cooling plate, or electronics mounting plate 510 disposed above the cell and interconnection region. The plate 510 may provide electrical isolation, mechanical reinforcement, thermal spreading, mounting support, or protection for internal wiring and sensing components. In some embodiments, the plate 510 may support one or more battery management circuit boards, current sensors, temperature sensors, strain sensors, pressure sensors, fuses, contactors, manual service disconnects, coolant manifolds, or communication connectors.

In some embodiments, intermediate plate 510 may support one or more battery management circuit boards, current sensors, temperature sensors, strain sensors, pressure sensors, fuses, contactors, manual service disconnects, coolant manifolds, or communication connectors. Intermediate plate 510 may include mounting bosses, threaded inserts, cable routing channels, connector cutouts, or sealing surfaces that may facilitate assembly and service of these components.

Intermediate plate 510 may also serve as a thermal interface between electrochemical cells 504 and external cooling systems. For example, intermediate plate 510 may include integrated cooling channels, coolant passages, or thermal interface surfaces that connect to liquid cooling systems, air cooling systems, or phase-change cooling systems. In liquid-cooled embodiments, intermediate plate 510 may include coolant inlet and outlet connections, internal flow channels, and thermal interface materials that may efficiently transfer heat from electrochemical cells 504 to the coolant.

As shown in FIG. 5, one or more wiring harnesses, flexible conductors, sensor leads, or connector assemblies 512 may be routed toward a front service end 514 of the battery pack 202. The front service end 514 may include high-voltage terminals, low-voltage communication connectors, coolant quick-disconnect fittings, handles, fasteners, indicators, manual service disconnects, or other service-accessible components. The routing of the conductors toward the front service end 514 may allow the battery pack 202 to be installed, disconnected, tested, or replaced from the service side of the BESS DC block 100.

Front service end 514 may include high-voltage terminals, low-voltage communication connectors, coolant quick-disconnect fittings, handles, fasteners, indicators, manual service disconnects, or other service-accessible components. The high-voltage terminals may be configured as bolted connections, compression connections, or plug-in connections that mate with corresponding terminals in the BESS DC block 100. The terminals may be shrouded, covered, or otherwise protected to prevent accidental contact during service operations.

The routing of the conductors toward front service end 514 may allow battery pack 202 to be installed, disconnected, tested, or replaced from the service side of the BESS DC block 100 without requiring access to the rear or sides of battery pack 202. This front-service architecture may improve safety, reduce service time, and allow battery pack replacement without disturbing adjacent battery packs or cooling systems.

The battery pack 202 may further include an upper cover 516 configured to enclose and protect the cells 504, interconnection layer 508, sensor wiring, and internal control components. The upper cover 516 may be attached to the base tray 502 by fasteners, welding, adhesive, clamps, seals, gaskets, or other fastening structures. In some embodiments, the upper cover 516 may include reinforcing ribs, insulating structures, venting features, pressure relief features, thermal interface surfaces, or environmental sealing features.

In some embodiments, upper cover 516 may include reinforcing ribs, corrugations, or other structural features that can provide mechanical stiffness and resistance to deformation under load. Upper cover 516 may also include insulating structures or barriers that may provide additional electrical isolation between internal components and external surfaces. Venting features, pressure relief valves, or rupture discs may be integrated into upper cover 516 to safely release gases in the event of cell failure or thermal runaway.

Upper cover 516 may include thermal interface surfaces, heat sinks, or cooling fins that may facilitate heat rejection from battery pack 202 to the surrounding environment. In air-cooled applications, upper cover 516 may include external fins, heat spreaders, or thermal interface materials that can improve heat transfer to ambient air or forced-air cooling systems.

In some embodiments, the battery pack 202 may include liquid-cooling or thermal management components. For example, one or more cooling plates, coolant channels, coolant manifolds, or thermal interface materials may be positioned adjacent to the cells 504 or between layers of the pack. Coolant fittings at the front service end 514 may connect the battery pack 202 to a rack-level or container-level cooling system. The liquid cooling system may use water, glycol, dielectric fluids, or other suitable coolants depending on the operating temperature range, environmental conditions, and safety requirements. The cooling system may be configured for single-phase liquid cooling, two-phase cooling, or immersion cooling, depending on the thermal management requirements and system architecture.

In some embodiments, battery pack 202 may include a gas fire protection system 520 that may route a fire suppression gas to electrochemical cells 504 in the event of a thermal issue inside battery pack 202. Gas fire protection system 520 may include gas storage vessels, distribution manifolds, nozzles, temperature sensors, smoke detectors, or control valves that may automatically deploy fire suppression agents when predetermined conditions are detected. The fire suppression system may use inert gases such as nitrogen or argon, chemical suppression agents, or other suitable fire suppression technologies. Gas fire protection system 520 may be integrated with the battery management system to provide coordinated response to thermal events. For example, upon detection of elevated temperature, smoke, or other indicators of thermal runaway, the system may simultaneously disconnect battery pack 202 from external circuits, activate cooling systems, deploy fire suppression agents, and communicate alarm conditions to external monitoring systems.

The battery pack 202 may also include safety and monitoring components, including voltage sensing connections, temperature sensors, strain or pressure sensors, current sensing elements, fuses, contactors, pyrotechnic disconnects, service disconnects, insulation monitoring connections, and a pack-level battery management circuit. The pack-level battery management circuit may monitor cell voltages, pack voltage, pack current, temperature, strain, pressure, service disconnect status, and fault conditions, and may communicate such information to a rack-level or container-level controller. The pack-level battery management circuit may be implemented using the battery module controller 640 described in previous figures, and may monitor cell voltages with accuracy of ±5 mV or better, pack voltage and current, temperature at multiple locations within the pack, strain, pressure, or swelling of the pack structure, service disconnect status and interlock circuits, and fault conditions such as overvoltage, undervoltage, overcurrent, overtemperature, and insulation faults. The battery management circuit may communicate such information to a rack-level or container-level controller using CAN bus, Ethernet, or other suitable communication protocols.

In an alternative embodiment, battery pack 202 may be configured as a modular cell replacement system where individual electrochemical cells 504 or small groups of cells can be replaced without replacing the entire battery pack 202. In this embodiment, electrical interconnection layer 508 may include plug-in connections or quick-disconnect features that may allow individual cells or cell modules to be removed and replaced. Base tray 502 may include removable cell holders or trays that may facilitate cell replacement, and the battery management system may include cell-level identification and configuration capabilities that may automatically recognize and configure replacement cells.

This modular cell replacement approach may significantly reduce maintenance costs and improve system availability by allowing failed cells to be replaced quickly without requiring replacement of the entire battery pack 202. The system may include automated cell testing and balancing capabilities that may bring replacement cells to the appropriate state of charge and verify proper operation before returning the pack to service.

The layered construction shown in FIG. 5 provides a modular battery pack architecture in which cells, busbars, insulation, cooling components, sensing components, electronics, and enclosure components may be assembled into a serviceable high-voltage pack. The arrangement may improve manufacturability, electrical isolation, thermal control, structural rigidity, safety monitoring, and field replacement of the battery pack 202.

The configuration shown in FIG. 5 is illustrative and is not intended to limit the invention to the particular number, type, shape, or arrangement of cells, plates, covers, conductors, connectors, or support structures shown. In other embodiments, the battery pack 202 may include different cell types, different cell quantities, different busbar arrangements, different cooling structures, different sensing arrangements, or different enclosure configurations while still providing a high-voltage battery pack suitable for use in the BESS DC block 100.

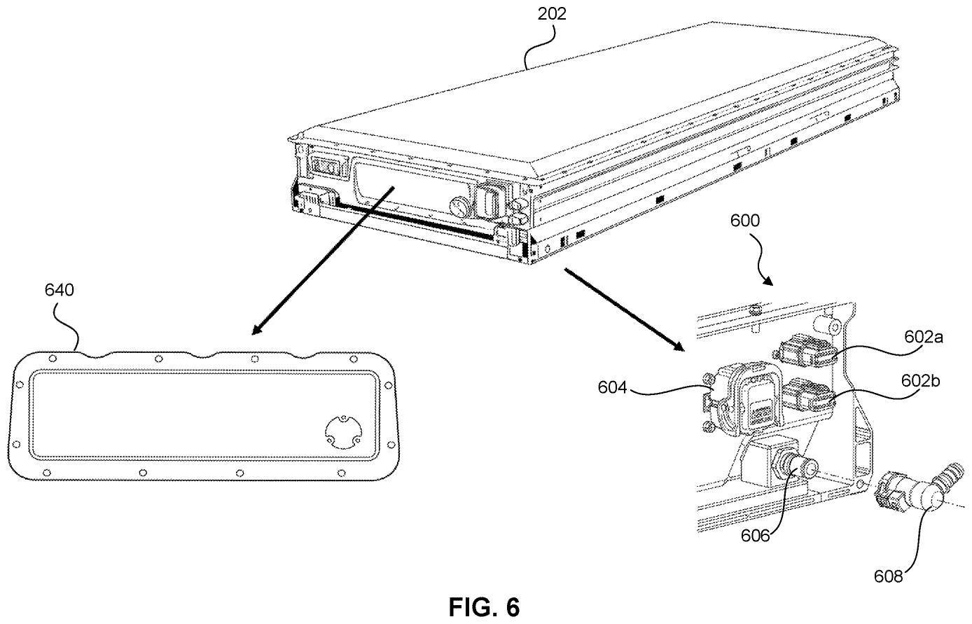

FIG. 6 illustrates an example battery module controller 640 and example service connectors that may be used with battery packs 202 according to embodiments of the present invention. As shown in section 600 of battery pack 202, in embodiments, battery pack 202 includes two communications and power connectors 602a and 602b, a manual service disconnect (MSD) 604, and an HVAC coolant quick disconnect male plug 606 and a female coupler 608. The battery pack 202 may be configured for installation in the BESS DC block 100 and may include a front service region or connector region that provides electrical, communication, control, safety, and coolant interfaces accessible from a service side of the battery pack 202.

As shown in FIG. 6, the battery pack 202 may include a battery module controller 640. The battery module controller 640 may be mounted at or near a front end of the battery pack 202 and may include control electronics, battery monitoring circuitry, cell balancing circuitry, temperature sensing circuitry, current sensing circuitry, strain or pressure sensing circuitry, communication circuitry, and safety-control circuitry. In some embodiments, the battery module controller 640 may monitor individual cell voltages, pack voltage, pack current, pack temperature, coolant temperature, service disconnect status, connector status, and fault conditions associated with the battery pack 202.

Battery module controller 640 may be housed within a ruggedized enclosure designed to withstand the harsh operating environment of a containerized BESS DC block. For example, the controller housing may be constructed from aluminum, steel, or composite materials and may include environmental sealing features such as gaskets, O-rings, or potting compounds to protect internal electronics from moisture, dust, vibration, and temperature extremes. In some embodiments, the controller housing may be rated to IP65, IP67, or higher ingress protection standards to ensure reliable operation in outdoor installations, marine environments, or industrial facilities.

The battery module controller 640 may communicate with a rack-level controller, container-level controller, battery management system, power conversion system, or energy management system. The battery module controller 640 may transmit operating data, state-of-charge data, state-of-health data, temperature data, diagnostic data, balancing status, and fault information. The battery module controller 640 may also receive control commands, configuration data, firmware updates, or operating limits from an external controller.

Battery module controller 640 may include advanced safety monitoring capabilities beyond conventional voltage and temperature sensing. For instance, controller 640 may monitor individual cell internal resistance, impedance spectroscopy data, gas concentration levels, electrolyte leakage detection, thermal runaway precursors, and mechanical stress indicators. These enhanced monitoring capabilities may enable early detection of cell degradation, abuse conditions, or safety hazards before they escalate to catastrophic failures.

FIG. 6 further illustrates a section 600 of the battery pack 202 showing example connector arrangements. In the illustrated embodiment, the battery pack 202 includes first and second communication and power connectors 602a and 602b. The communication and power connectors 602a, 602b may provide low-voltage power, communication signals, control signals, interlock signals, addressing signals, diagnostic signals, or auxiliary power connections to the battery module controller 640. In some embodiments, the two connectors 602a, 602b may permit daisy-chain connection between adjacent battery packs, redundant communication paths, separate input and output harness connections, or independent service and operational interfaces.

First communication and power connector 602a and second communication and power connector 602b may be implemented as multi-pin circular connectors, rectangular connectors, or modular connectors designed for high-reliability applications. For example, the connectors may include gold-plated contacts, hermetic sealing, vibration-resistant locking mechanisms, and color-coded housings to prevent mis-mating. In some embodiments, connectors 602a, 602b may include built-in LED status indicators that can provide visual feedback regarding communication status, power status, fault conditions, or connector engagement.

The communication and power connectors 602a, 602b may support CAN, isolated CAN, RS-485, Ethernet, serial communication, discrete fault signaling, wake signals, enable signals, pack-present detection, or other communication and control protocols. The connectors 602a, 602b may also include one or more low-voltage supply conductors and ground conductors used to power pack-level electronics, sensors, relays, or other auxiliary components.

First communication and power connector 602a and second communication and power connector 602b may support CAN, isolated CAN, RS-485, Ethernet, serial communication, discrete fault signaling, wake signals, enable signals, pack-present detection, or other communication and control protocols. Connectors 602a, 602b may also include one or more low-voltage supply conductors and ground conductors used to power pack-level electronics, sensors, relays, or other auxiliary components. In advanced embodiments, the connectors may support high-speed data protocols such as Gigabit Ethernet, fiber optic communication, or wireless communication interfaces for enhanced data throughput and system integration capabilities.

The dual-connector arrangement may provide several operational advantages. For instance, connector 602a may serve as a primary communication interface during normal operation, while connector 602b may function as a backup communication path or service interface. This redundancy may ensure continued operation even if one connector becomes damaged or disconnected. Additionally, the dual connectors may support hot-swappable operation, allowing battery packs to be replaced without shutting down the entire BESS DC block.

The battery pack 202 may further include a manual service disconnect (MSD) 604. The MSD 604 may be configured as a removable plug, switch, fuse carrier, interlock device, or service-accessible disconnect that manually opens or interrupts a high-voltage circuit within the battery pack 202. The MSD 604 may allow a technician to place the battery pack 202 in a safer condition before installation, removal, inspection, maintenance, shipping, or repair.

In some embodiments, MSD disconnect 604 may be implemented as a keyed disconnect device that requires a special tool or key to operate, preventing unauthorized or accidental activation. The MSD 604 may include visual indicators such as colored flags, position indicators, or status windows that clearly show whether the disconnect is in the open or closed position. For enhanced safety, the MSD 604 may include multiple break points, arc suppression features, or time-delay mechanisms to ensure safe interruption of high-voltage circuits under load conditions.

In some embodiments, the MSD 604 may include a high-voltage interlock loop or other status signal connected to the battery module controller 640. The battery module controller 640 may detect whether the manual service disconnect 604 is installed, removed, open, closed, latched, or improperly seated. In response to the detected state of the manual service disconnect 604, the battery module controller 640 may disable charging, disable discharging, inhibit contactor closing, stop balancing, generate a fault signal, or communicate a service-disconnect status to an external controller.

The MSD 604 may also incorporate additional safety features such as mechanical interlocks that prevent removal while the pack is energized, tamper-evident seals for security applications, or RFID tags for automated inventory tracking. In some embodiments, the MSD 604 may be integrated with the pack's fire suppression system, automatically activating gas discharge or other suppression mechanisms when removed.

As further shown in section 600, the battery pack 202 may include coolant quick-disconnect components, including an HVAC coolant quick-disconnect male plug 606 and a corresponding female coupler 608. The male plug 606 and female coupler 608 may be configured to connect the battery pack 202 to a liquid cooling system associated with the BESS DC block 100. The coolant quick-disconnect components may allow coolant supply and return lines to be connected or disconnected during battery pack installation, removal, replacement, or service.

In some embodiments, the male plug 606 and female coupler 608 may be dry-break or low-spill coolant quick-disconnect fittings. The fittings may include internal valves that close when disconnected to reduce coolant leakage and to reduce the likelihood of air entering the coolant loop. The coolant quick-disconnect fittings may be connected to internal coolant passages, cold plates, cooling channels, manifolds, or thermal management structures within the battery pack 202.

Coolant quick-disconnect fittings 606, 608 may be designed to handle various coolant types including water-glycol mixtures, dielectric fluids, phase-change materials, or specialized battery cooling fluids. The fittings may be constructed from corrosion-resistant materials such as stainless steel, brass, or engineered plastics to ensure long-term compatibility with different coolant chemistries. In some embodiments, the fittings may include temperature sensors, flow sensors, or pressure sensors to monitor coolant conditions and detect potential issues such as blockages, leaks, or pump failures.

The coolant system may operate in various configurations depending on the application requirements. For example, the system may use series flow where coolant passes through multiple battery packs sequentially, parallel flow where each pack receives coolant from a common manifold, or hybrid configurations that combine series and parallel elements. Quick-disconnect fittings 606, 608 may be color-coded or keyed to prevent incorrect connections and ensure proper coolant flow direction.

In advanced embodiments, the coolant quick-disconnect system may include smart features such as automatic leak detection, flow rate monitoring, coolant quality sensing, or predictive maintenance algorithms. The system may also support different cooling modes such as active cooling during high-power operation, passive cooling during standby periods, or emergency cooling during fault conditions.

The arrangement shown in FIG. 6 provides a serviceable front-interface architecture for the battery pack 202. By locating the battery module controller 640, communication and power connectors 602a, 602b, MSD 604, and coolant quick-disconnect fittings 606, 608 at or near a service-accessible region of the battery pack 202, the battery pack 202 may be installed, connected, disconnected, isolated, tested, removed, or replaced from the service side of the BESS DC block 100.

This front-service design philosophy may extend beyond the components shown in FIG. 6. For example, battery pack 202 may include additional service-accessible features such as diagnostic ports, calibration interfaces, firmware programming connectors, or test points positioned at the front service region. The pack may also include service documentation holders, QR codes for digital manuals, or augmented reality markers to assist technicians during maintenance procedures.

The modular connector arrangement may enable rapid field service and reduce system downtime. For instance, a technician can quickly disconnect all interfaces, slide out a faulty battery pack, slide in a replacement pack, and reconnect all interfaces in a matter of minutes. This hot-swappable capability may be particularly valuable in critical applications where continuous power availability is essential.

This configuration may improve manufacturability, field serviceability, safety, diagnostic access, coolant connection reliability, and modular replacement of the battery pack 202. The configuration shown in FIG. 6 is illustrative and is not intended to limit the invention to the particular number, type, location, or arrangement of connectors, service disconnects, coolant fittings, or controller components shown. In other embodiments, the battery pack 202 may include additional or fewer connectors, different connector types, different coolant fitting arrangements, different service disconnect structures, or different controller mounting locations while still providing a modular service interface for a high-voltage battery pack used in the BESS DC block 100.

In an alternative embodiment, battery pack 202 may incorporate wireless communication capabilities in addition to or instead of the wired connectors 602a, 602b. For example, battery module controller 640 may include Wi-Fi, Bluetooth, Zigbee, LoRa, or cellular communication modules that enable remote monitoring, diagnostics, and control without physical cable connections. This wireless approach may be particularly advantageous in applications where cable routing is challenging, where electromagnetic interference is a concern, or where enhanced mobility is required.

The wireless communication system may operate on dedicated frequencies to avoid interference with other systems and may include encryption, authentication, and cybersecurity features to protect against unauthorized access. The system may support mesh networking topologies where battery packs can relay communications through neighboring packs, providing redundant communication paths and extended range.

In another alternative embodiment, the coolant system may be replaced with or supplemented by alternative thermal management approaches. For example, battery pack 202 may include thermoelectric cooling elements, heat pipes, phase-change materials, or air cooling systems. The quick-disconnect fittings may be adapted to support these alternative cooling methods, such as electrical connections for thermoelectric coolers or pneumatic connections for air cooling systems.

Battery pack 202 may also include integrated fire suppression capabilities that interface with the service connectors. For example, the pack may include gas discharge ports, suppression agent reservoirs, or thermal barriers that can be activated remotely through the communication connectors or automatically through battery module controller 640. This integrated approach may provide enhanced safety while maintaining the modular service architecture.

The configuration shown in FIG. 6 is illustrative and is not intended to limit the invention to the particular number, type, location, or arrangement of connectors, service disconnects, coolant fittings, or controller components shown. In other embodiments, battery pack 202 may include additional or fewer connectors, different connector types, different coolant fitting arrangements, different service disconnect structures, or different controller mounting locations while still providing a modular service interface for a high-voltage battery pack used in BESS DC block 100.

For example, some embodiments may include additional specialized connectors for specific applications such as grid-tie monitoring, islanding detection, power quality measurement, or integration with renewable energy sources. Battery pack 202 may also include connectors for external sensors, environmental monitoring equipment, or auxiliary power systems that support the broader BESS installation.

The scalability of the connector system may allow for future expansion and technology upgrades. New connector types can be added to support emerging communication protocols, enhanced safety features, or advanced monitoring capabilities without requiring redesign of the entire battery pack architecture. This forward-compatibility may ensure that BESS DC block 100 can adapt to evolving industry standards and customer requirements over its operational lifetime.

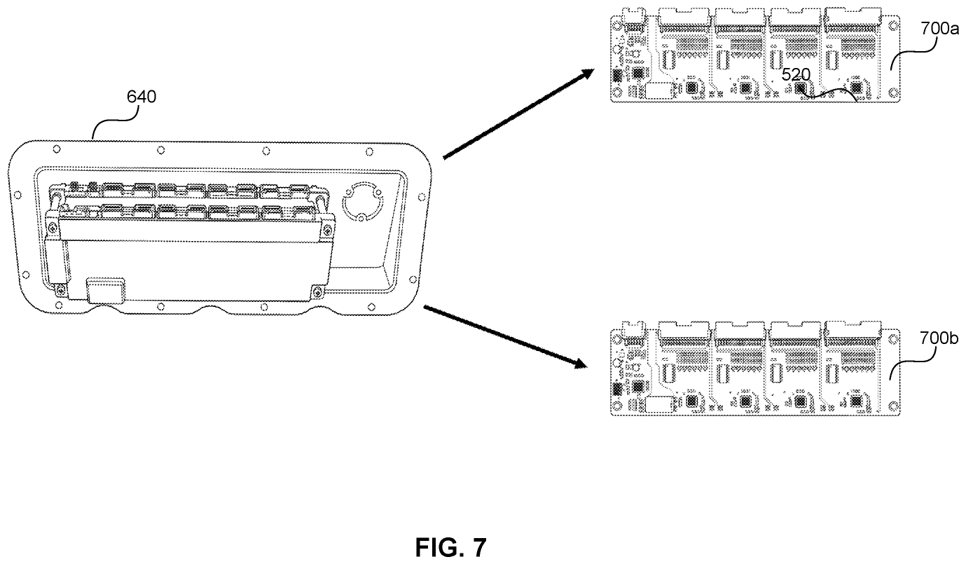

FIG. 7 further illustrates an example battery module controller 640 according to an embodiment of the present invention. The battery module controller 640 may be mounted in, on, or adjacent to a front service region of the battery pack 202 and may provide pack-level monitoring, control, communication, balancing, safety, and diagnostic functions for the battery pack 202.

As shown in FIG. 7, the battery module controller 640 includes a first printed circuit board 700a and a second printed circuit board 700b. The printed circuit boards 700a, 700b may be positioned within a controller housing, carrier, bracket, enclosure, or service-accessible compartment associated with the battery pack 202. In some embodiments, the printed circuit boards 700a, 700b may be arranged in parallel, stacked, side-by-side, or otherwise mounted within the battery module controller 640 to divide electrical functions between multiple circuit assemblies.

The first printed circuit board 700a may include one or more battery monitoring circuits, cell-voltage sensing circuits, balancing circuits, communication circuits, power conversion circuits, isolation circuits, temperature sensing circuits, strain or pressure sensing circuits, or connector interfaces. The second printed circuit board 700b may include similar or complementary circuits. In one embodiment, the printed circuit boards 700a, 700b may be configured to monitor different groups of cells within the battery pack 202, different portions of a high-voltage cell string, or different sensor groups within the battery pack 202.

In some embodiments, use of two printed circuit boards 700a, 700b allows the battery module controller 640 to support a larger number of cell voltage inputs, temperature inputs, pressure or strain inputs, balancing channels, communication channels, or connector interfaces than would be practical on a single printed circuit board. The two-board arrangement may also allow physical separation of high-voltage sensing circuits, low-voltage logic circuits, isolated communication circuits, power supply circuits, and service connector circuits.

The battery module controller 640 may be electrically connected to cells, busbars, fuses, current sensors, thermistors, strain sensors, pressure sensors, coolant sensors, manual service disconnects, communication connectors, and auxiliary power connectors within the battery pack 202. The controller 640 may receive cell voltage signals, pack voltage signals, current signals, temperature signals, strain or pressure signals, interlock signals, and service disconnect status signals. The controller 640 may process these signals to determine operating condition, state of charge, state of health, fault status, thermal condition, mechanical condition, and balancing requirements of the battery pack 202.

In a specific embodiment, first printed circuit board 700a may be configured as a primary monitoring and control board that includes a microcontroller unit (MCU), primary communication interfaces, power management circuits, and cell voltage monitoring circuits for a first subset of cells within battery pack 202. For example, first printed circuit board 700a may monitor cells 1 through 16 of a 32-cell battery pack. First printed circuit board 700a may include analog-to-digital converters, voltage reference circuits, multiplexers, isolation amplifiers, and signal conditioning circuits optimized for accurate cell voltage measurement across varying temperature and operating conditions.

Second printed circuit board 700b may be configured as a secondary monitoring board that includes cell voltage monitoring circuits for a second subset of cells within battery pack 202. For example, second printed circuit board 700b may monitor cells 17 through 32 of the same 32-cell battery pack. Second printed circuit board 700b may include similar voltage sensing circuits, temperature sensing circuits, and balancing circuits as first printed circuit board 700a, but may operate under the control of the MCU located on first printed circuit board 700a.

In another embodiment, both printed circuit boards 700a, 700b may include substantially identical circuits and may operate as redundant monitoring systems. In this configuration, first printed circuit board 700a may serve as the primary controller while second printed circuit board 700b serves as a backup or validation controller. Both boards may monitor the same cells and compare measurements to detect sensor failures, wiring faults, or circuit malfunctions. If the primary controller fails, the secondary controller may assume control of battery pack 202.

The printed circuit boards 700a, 700b may communicate with each other through board-to-board connectors, cable harnesses, edge connectors, internal buses, or other electrical interconnects. In some embodiments, one printed circuit board may operate as a primary controller board and the other printed circuit board may operate as an auxiliary sensing, balancing, isolation, or expansion board. In other embodiments, both printed circuit boards may operate as substantially similar monitoring boards assigned to different cell groups or pack sections.

For example, first printed circuit board 700a may include a CAN communication controller, isolated CAN transceivers, and external communication connectors for communicating with rack-level or container-level controllers. Second printed circuit board 700b may communicate with first printed circuit board 700a through a high-speed serial interface, SPI bus, I2C bus, or dedicated parallel interface. This arrangement may allow second printed circuit board 700b to focus on sensor data acquisition while first printed circuit board 700a handles communication protocols, data processing, and external interfaces.

Battery module controller 640 may include advanced cell balancing circuits distributed across both printed circuit boards 700a, 700b. In one embodiment, each printed circuit board may include balancing circuits for its assigned cell groups. The balancing circuits may include active balancing circuits that use magnetic energy transfer, capacitive energy transfer, or resistive balancing techniques. For example, first printed circuit board 700a may include flyback converters, forward converters, or LLC resonant converters that can transfer energy between cells or between cells and an external energy source.

In a specific implementation, the balancing circuits may use high-frequency AC power derived from grid power to provide balancing energy. Battery module controller 640 may include isolation transformers, rectifier circuits, and switching circuits that allow individual cells to be charged using energy from the grid rather than energy from other cells within the pack. This approach may allow balancing to occur during charging, discharging, or idle periods without depleting the energy stored in the battery pack.

The printed circuit boards 700a, 700b may include multiple temperature sensing inputs configured to monitor cell temperatures, ambient temperatures, coolant temperatures, and circuit board temperatures. Temperature sensors may include thermistors, RTDs, thermocouples, or integrated temperature sensors positioned at various locations within battery pack 202. The temperature sensing circuits may include precision voltage references, low-noise amplifiers, and calibration circuits to provide accurate temperature measurements across the operating temperature range of the battery pack.

In addition to voltage and temperature monitoring, battery module controller 640 may include mechanical condition sensing circuits. These circuits may be connected to strain gauges, load cells, pressure sensors, or displacement sensors positioned within or adjacent to the battery cells. The mechanical condition sensing circuits may detect cell swelling, compression, mechanical stress, or other physical changes that may indicate cell degradation, thermal runaway, or safety hazards.

The battery module controller 640 may further communicate with a rack-level controller, container-level controller, power conversion system, external battery management system, or energy management system. Communication may be provided through CAN, isolated CAN, RS-485, Ethernet, serial communication, discrete fault lines, wake lines, enable lines, or other communication and control interfaces. The controller 640 may transmit cell voltages, pack voltage, pack current, temperature measurements, strain or pressure measurements, coolant information, balancing status, service disconnect status, diagnostic information, and fault codes.

In some embodiments, the battery module controller 640 may control one or more battery pack functions, including cell balancing, relay actuation, contactor enablement, coolant valve operation, sensor excitation, fault detection, pack isolation, or safety shutdown. The controller 640 may disable charging, disable discharging, inhibit balancing, open a relay or contactor, or issue a fault signal if an abnormal condition is detected.

Battery module controller 640 may include power supply circuits that convert external power sources into the various DC voltages required by the monitoring, control, and balancing circuits. The power supply circuits may include switching regulators, linear regulators, isolated DC-DC converters, and power management circuits. In one embodiment, the power supply circuits may derive power from the battery pack itself, from external low-voltage sources, or from grid power connections.

The controller 640 may include diagnostic and calibration features that allow field testing, calibration, and troubleshooting of battery pack 202. For example, the controller may include built-in self-test circuits, calibration routines, diagnostic communication protocols, and test point access. Service technicians may connect diagnostic equipment to controller 640 to verify sensor accuracy, test balancing circuits, check communication interfaces, or update firmware.

In some embodiments, battery module controller 640 may include safety and protection circuits that provide multiple levels of fault detection and response. These circuits may include overvoltage protection, undervoltage protection, overcurrent protection, overtemperature protection, mechanical fault protection, and communication fault protection. The protection circuits may operate independently of the main control processor to provide fail-safe operation even if the primary control circuits malfunction.

The two printed circuit boards 700a, 700b may be removable or replaceable as service components. The controller housing or mounting arrangement may allow access to the printed circuit boards 700a, 700b from the front side of the battery pack 202, thereby improving assembly, inspection, firmware programming, calibration, troubleshooting, and field replacement.

In an alternative embodiment, battery module controller 640 may be implemented using a single, larger printed circuit board that integrates all monitoring, control, balancing, and communication functions. This single-board approach may reduce manufacturing complexity and cost while providing equivalent functionality. The single printed circuit board may include multiple microcontrollers, dedicated monitoring ICs, balancing controllers, and communication processors arranged in functional blocks across the board.

Another alternative embodiment may use a modular approach where battery module controller 640 includes a base controller board and one or more expansion boards. The base controller board may include the primary MCU, communication interfaces, and power supply circuits. Expansion boards may be added to support additional cells, additional sensors, enhanced balancing capabilities, or specialized functions such as insulation monitoring or arc fault detection.

Battery module controller 640 may also include wireless communication capabilities in addition to or instead of wired communication interfaces. Wireless communication may use WiFi, Bluetooth, Zigbee, LoRa, cellular, or other wireless protocols to communicate with external systems. Wireless communication may be particularly useful in applications where wired connections are difficult to implement or maintain.

In some embodiments, battery module controller 640 may include energy harvesting circuits that can derive operating power from ambient sources such as vibration, temperature differentials, or electromagnetic fields. Energy harvesting may provide backup power for critical monitoring functions or may reduce the power consumption of the controller during standby periods.

The configuration shown in FIG. 7 is illustrative and is not intended to limit the invention to exactly two printed circuit boards or to the particular layout shown. In other embodiments, the battery module controller 640 may include a single printed circuit board, more than two printed circuit boards, flexible circuits, mezzanine boards, daughter boards, different connector arrangements, different sensing circuits, different balancing circuits, or different communication interfaces while still providing pack-level control and monitoring for a battery pack 202.

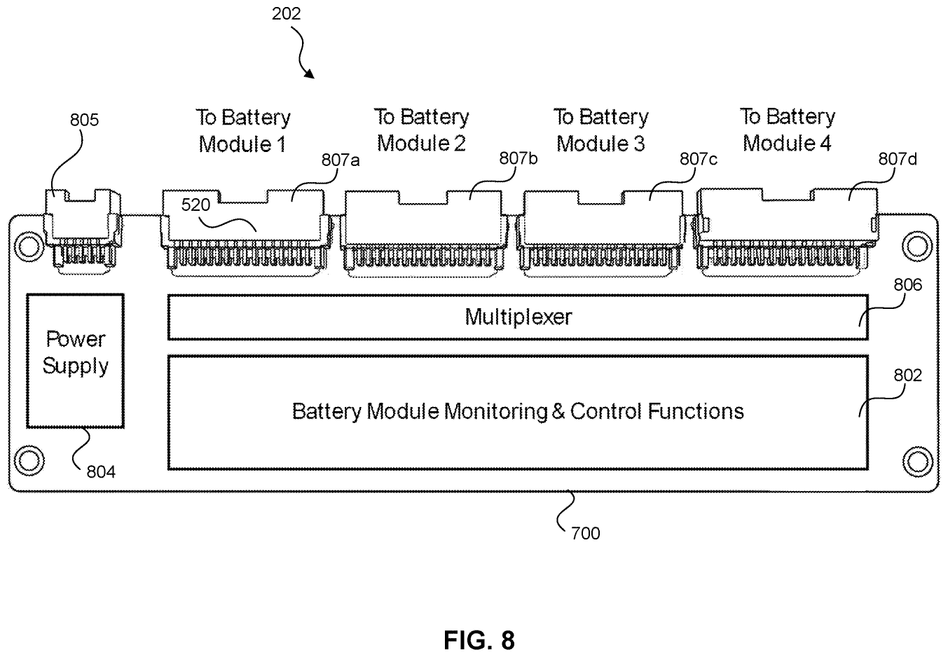

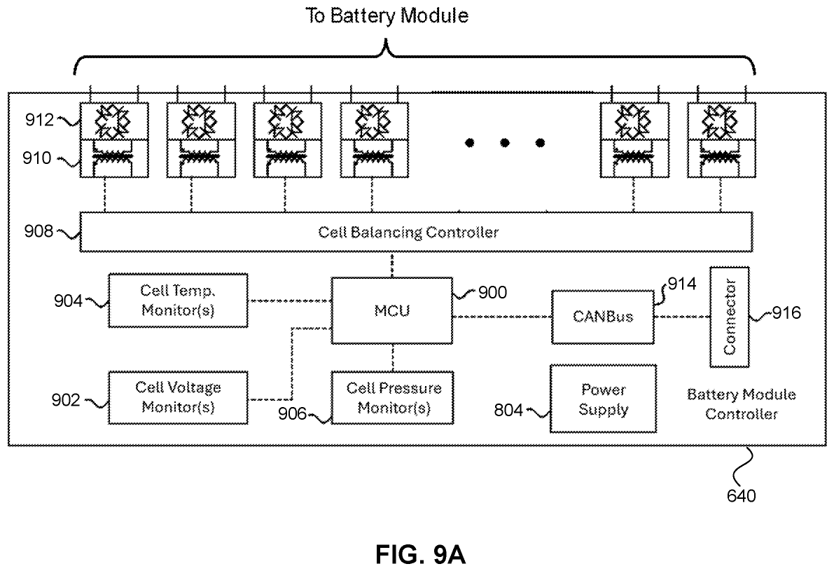

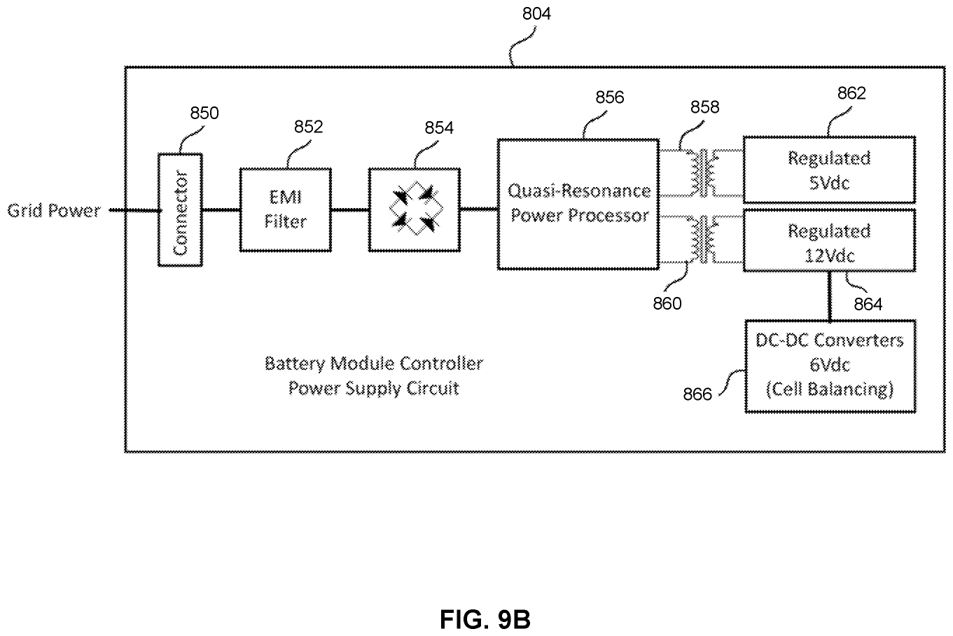

FIG. 8 further illustrates example printed circuit board 700 of a battery module controller according 640 to an embodiment of the present invention. As shown in FIG. 8, circuit board 700 includes a battery module monitoring and control circuit 802, a power supply 805, a power sully connector 805, and a multiplexer 806 to connect battery module monitoring and control circuit 802 to a plurality of battery cells via connectors 807a-d. these circuits are further described below with reference to FIGS. 9A-B, 10, 10A-Q, 11, 11A-D, and 12.

Printed circuit board 700 may be configured as a modular control and monitoring platform that can provide comprehensive battery management functionality for high-voltage battery packs 202 within the BESS DC block 100. Circuit board 700 may be mounted within the battery module controller 640 housing and may be accessible from a front service region of the battery pack 202 for installation, programming, calibration, troubleshooting, and field replacement.

Battery module monitoring and control circuit 802 may serve as the central processing and control hub for the battery module controller 640. In some embodiments, circuit 802 may include a microcontroller unit (MCU), analog-to-digital converters, digital signal processors, memory components, communication interfaces, input/output circuits, and safety monitoring circuits. Circuit 802 may be configured to execute firmware and software that can control all operational functions of the battery module controller 640, including cell voltage monitoring, temperature monitoring, pressure and strain monitoring, cell balancing control, communication with external controllers, fault detection, and safety management.

Battery module monitoring and control circuit 802 may continuously monitor the electrical, thermal, and mechanical condition of individual electrochemical cells within the battery pack 202. For example, circuit 802 may sample cell voltages at regular intervals to determine state of charge, detect cell imbalances, identify weak or failing cells, and calculate voltage deltas between the highest and lowest cell voltages. Circuit 802 may also process temperature data from multiple temperature sensors positioned throughout the battery pack 202 to detect thermal gradients, hot spots, cooling system performance, and thermal runaway conditions.

In some embodiments, battery module monitoring and control circuit 802 may include specialized analog front-end circuits optimized for high-precision voltage measurements across multiple cell groups. These circuits may provide galvanic isolation between cell measurement channels and the control logic to ensure safety and measurement accuracy in high-voltage applications. Circuit 802 may support simultaneous monitoring of 12, 16, 24, 32, or more individual cells, depending on the configuration of the battery pack 202.

Circuit 802 may further include cell balancing control logic configured to manage active or passive balancing operations. In active balancing embodiments, circuit 802 may control switching circuits, magnetic energy transfer elements, and regulator circuits to selectively transfer energy between cells or cell groups. The balancing control logic may determine which cells require balancing based on voltage measurements, temperature conditions, and user-defined balancing algorithms. Circuit 802 may implement top balancing, bottom balancing, or continuous balancing strategies depending on the application requirements and battery chemistry.

Power supply 804 may provide regulated DC voltages and high-frequency AC power required to operate all components of the battery module controller 640. Power supply 804 may be connected to external grid power through power supply connector 805 and may convert incoming AC power to multiple regulated output voltages. For example, power supply 804 may generate +5V, +12V, −12V, +3.3V, and +6V DC outputs to power the microcontroller, analog circuits, communication interfaces, sensors, and balancing circuits.

In a key embodiment of the invention, power supply 804 may also generate high-frequency AC power for cell balancing operations. Unlike conventional battery management systems that derive balancing energy from the battery cells themselves, power supply 804 may convert grid AC power (typically 100-240 VAC at 50/60 Hz) to a much higher frequency AC signal, such as 100 kHz or other suitable frequencies ranging from 10 kHz to 1 MHz. This high-frequency AC power may then be supplied to isolation transformers and balancing circuits to provide balancing energy that can be independent of the battery pack's stored energy.

Power supply 804 may include electromagnetic interference (EMI) filtering, rectification circuits, quasi-resonant power processing circuits, and multiple isolation transformers to ensure safe and efficient power conversion. In some embodiments, power supply 804 may be implemented using specialized power management integrated circuits, such as the Infineon Technologies 5QR1680AG or similar quasi-resonant controller chips that can provide high efficiency and low electromagnetic emissions.

Power supply connector 805 may provide the electrical interface between power supply 804 and external grid power or auxiliary power sources. Connector 805 may be configured as a standard AC power connector, terminal block, or specialized connector suitable for the operating environment of the BESS DC block 100. In some embodiments, power supply connector 805 may include multiple power input options to support different grid voltages, backup power sources, or redundant power feeds.

Power supply connector 805 may also include safety features such as ground fault detection, overcurrent protection, surge protection, and isolation monitoring. These features may protect the battery module controller 640 and associated battery pack 202 from power grid disturbances, electrical faults, and installation errors. Power supply connector 805 may be accessible from the front service region of the battery pack 202 to facilitate installation and maintenance.

Multiplexer 806 may provide a scalable interface between battery module monitoring and control circuit 802 and multiple battery modules or cell groups. Multiplexer 806 may allow a single battery module controller 640 to monitor and control multiple battery packs 202, thereby reducing system cost and complexity in large-scale BESS installations. In the illustrated embodiment, multiplexer 806 may be connected to four separate battery modules through connector to battery module 1 807a, connector to battery module 2 807b, connector to battery module 3 807c, and connector to battery module 4 807d.

Each of connector to battery module 1, connector to battery module 2, connector to battery module 3, and connector to battery module 4 may provide electrical connections for cell voltage sensing, temperature sensing, pressure or strain sensing, balancing control, and communication with individual battery modules. The connectors may be configured as multi-pin connectors, ribbon cable connectors, or modular connectors that can allow reliable connection and disconnection during installation, maintenance, and replacement operations. In some embodiments, connector to battery module 1, connector to battery module 2, connector to battery module 3, and connector to battery module 4 may include keying, polarization, or coding features to prevent incorrect connections.

Multiplexer 806 may include analog switching circuits, digital switching circuits, or a combination of both to route signals between battery module monitoring and control circuit 802 and the selected battery module. Multiplexer 806 may operate under control of circuit 802 to sequentially or selectively monitor different battery modules, thereby allowing time-division monitoring of multiple battery packs using shared measurement and control circuits.

In some embodiments, multiplexer 806 may provide electrical isolation between different battery modules to prevent ground loops, reduce noise, and improve safety. The multiplexer may include optical isolators, magnetic isolators, or transformer-based isolation circuits to maintain galvanic separation between high-voltage battery circuits and low-voltage control circuits.

Multiplexer 806 may also include diagnostic and fault detection capabilities. For example, the multiplexer may detect open circuits, short circuits, connector faults, or communication failures associated with individual battery modules. Multiplexer 806 may report such faults to battery module monitoring and control circuit 802, which may then take appropriate action such as isolating the faulty module, generating alarm signals, or communicating fault information to higher-level controllers.

In an alternative embodiment, printed circuit board 700 may be configured to control a single high-capacity battery pack 202 rather than multiple smaller battery modules. In this configuration, multiplexer 806 may be replaced with direct connection circuits, and connector to battery module 1, connector to battery module 2, connector to battery module 3, and connector to battery module 4 may be configured to connect to different cell groups, temperature sensor groups, or balancing circuit groups within a single large battery pack. This alternative configuration may be suitable for applications requiring higher energy density or simplified system architecture.

Printed circuit board 700 may also include additional circuits and components not explicitly shown in FIG. 8. For example, the board 700 may include communication interfaces such as CAN bus transceivers, RS-485 drivers, Ethernet controllers, or wireless communication modules. The board may include safety circuits such as watchdog timers, voltage supervisors, thermal shutdown circuits, and emergency stop interfaces. The board may include diagnostic circuits such as built-in self-test circuits, calibration circuits, and performance monitoring circuits.

In some embodiments, printed circuit board 700 may include user interface components such as status LEDs, diagnostic displays, configuration switches, or test points. These components may be accessible from the front service region of the battery pack 202 to provide visual indication of controller status and to facilitate troubleshooting and maintenance operations.

The layout and design of printed circuit board 700 may be optimized for the harsh operating environment of battery energy storage systems. The board may use automotive-grade or industrial-grade components rated for extended temperature ranges, high humidity, vibration, and electromagnetic interference. The board may include conformal coating, potting compounds, or other environmental protection measures to ensure reliable operation in containerized BESS installations.

Printed circuit board 700 may be designed for field replaceability and serviceability. The board may include standardized mounting features, connector locations, and form factors that can allow replacement boards to be installed without requiring rewiring or mechanical modifications. The board may include non-volatile memory components that can retain configuration data, calibration parameters, and operational history even when power is removed.

In some embodiments, battery module monitoring and control circuit 802 may implement advanced battery management algorithms that can consider not only voltage and temperature measurements, but also mechanical condition measurements such as cell swelling, pressure, strain, and compression. These algorithms may detect early signs of cell degradation, thermal runaway, or mechanical failure that could lead to safety hazards or system failures. Circuit 802 may automatically adjust balancing operations, charging limits, discharging limits, or cooling system operation based on these measurements.

The configuration shown in FIG. 8 may provide a scalable and modular architecture for battery management in large-scale energy storage systems. By using a single printed circuit board 700 to control multiple battery modules through multiplexer 806, the system may achieve cost savings, reduced complexity, and improved reliability compared to systems that require individual controllers for each battery module. The centralized control approach may also facilitate coordinated balancing operations, system-level optimization, and simplified communication with higher-level controllers.

The arrangement shown in FIG. 8 may be illustrative and is not intended to limit the invention to the particular number, type, or configuration of circuits, connectors, or components shown. In other embodiments, printed circuit board 700 may include different numbers of connectors, different multiplexer configurations, different power supply arrangements, different communication interfaces, or different monitoring and control circuits while still providing comprehensive battery management functionality for high-voltage battery packs in containerized BESS applications.

FIG. 9A further illustrates example battery module controller 640. As shown in FIG. 9A, in addition to power supply 804, battery module controller 640 includes a microcontroller unit (MCU) 900, cell voltage monitors 902, cell temperature monitors 904, cell pressure monitors 906, a cell balancing controller 908, balancing transformers 910, and balancing rectifiers 912. In an embodiment, MCU 900 communicates with a higher-level controller using a CANBus communications circuit 914. The CANBus communications circuit is connected to the higher-level controller using a connector 916. In an embodiment, the higher-level controller is a battery rack controller as described herein.

MCU 900 may be implemented as a 32-bit ARM Cortex-M microprocessor, an 8-bit microcontroller, a digital signal processor (DSP), a field-programmable gate array (FPGA), or other suitable processing device capable of executing firmware and software instructions. In some embodiments, MCU 900 may include integrated analog-to-digital converters (ADCs), pulse-width modulation (PWM) outputs, timer circuits, communication peripherals, watchdog circuits, and memory interfaces. MCU 900 may execute real-time operating system (RTOS) software or bare-metal firmware configured to perform battery monitoring, balancing control, communication protocols, fault detection, safety monitoring, and diagnostic functions.

MCU 900 may include multiple processing cores, hardware security modules, cryptographic accelerators, or safety-certified processing elements to support functional safety requirements such as ISO 26262 or IEC 61508. In some embodiments, MCU 900 may implement redundant processing, error correction, memory protection, or fail-safe operating modes to ensure reliable operation in safety-critical battery applications.

Cell voltage monitor(s) 902 may include one or more battery monitoring integrated circuits (BMICs), analog front-end circuits, multiplexed ADC circuits, or dedicated voltage sensing circuits configured to measure individual cell voltages within the battery pack 202. In some embodiments, cell voltage monitor(s) 902 may be implemented using devices such as the Texas Instruments BQ79616, Analog Devices ADBMS6815, NXP MC33771, or similar multi-channel battery monitoring circuits capable of measuring 12, 16, 18, or more cell voltages simultaneously.

Cell voltage monitor(s) 902 may provide galvanic isolation between high-voltage battery cells and low-voltage control circuits through capacitive isolation, magnetic isolation, or optical isolation techniques. Cell voltage monitor(s) 902 may include built-in cell balancing switches, over-voltage protection, under-voltage protection, communication interfaces, and diagnostic features. In some embodiments, multiple cell voltage monitor circuits 902 may be daisy-chained or connected in parallel to monitor larger numbers of cells within a high-voltage battery pack.

Cell voltage monitor(s) 902 may sample cell voltages at rates of 1 Hz to 1 kHz or higher, depending on application requirements. The voltage measurement accuracy may be ±1 mV to ±5 mV or better, with resolution of 0.1 mV to 1 mV. Cell voltage monitor(s) 902 may include programmable over-voltage and under-voltage thresholds, cell voltage balancing thresholds, and fault detection capabilities.

Cell temperature monitor(s) 904 may include thermistor interface circuits, thermocouple interface circuits, resistance temperature detector (RTD) interface circuits, or integrated temperature sensor circuits configured to measure temperatures at multiple locations within the battery pack 202. In some embodiments, cell temperature monitor(s) 904 may interface with negative temperature coefficient (NTC) thermistors, positive temperature coefficient (PTC) thermistors, platinum RTDs, or semiconductor temperature sensors positioned adjacent to individual cells, cell groups, busbars, cooling plates, or ambient locations within the battery pack.

Cell temperature monitor(s) 904 may include signal conditioning, linearization, cold-junction compensation, excitation current sources, and multi-channel multiplexing capabilities. Temperature measurements may be performed with accuracy of ±0.5 °C to ±2 °C and resolution of 0.1 °C to 1 °C across operating temperature ranges of −40 °C to +85 °C or wider. Cell temperature monitor(s) 904 may include programmable temperature thresholds for over-temperature protection, under-temperature protection, thermal balancing control, and cooling system activation.

Cell pressure monitor(s) 906 may represent a novel and advantageous feature of the battery module controller 640 that addresses safety concerns related to battery cell swelling, gas generation, thermal runaway, and mechanical degradation. Cell pressure monitor(s) 906 may include strain gauge interface circuits, load cell interface circuits, pressure sensor interface circuits, displacement sensor interface circuits, or force sensor interface circuits configured to detect mechanical changes within individual cells or cell groups.

In some embodiments, cell pressure monitor(s) 906 may interface with resistive strain gauges, capacitive pressure sensors, piezoelectric force sensors, optical displacement sensors, or MEMS-based pressure sensors positioned adjacent to cell cases, between cell layers, within cell compression fixtures, or integrated into cell mounting structures. Cell pressure monitor(s) 906 may detect cell swelling caused by electrolyte decomposition, gas generation, lithium plating, thermal expansion, or other degradation mechanisms that can precede thermal runaway events.

Cell pressure monitor(s) 906 may provide early warning of potentially dangerous cell conditions before cell voltage or temperature measurements indicate abnormal operation. For example, a cell experiencing internal gas generation due to overcharging, over-temperature, or manufacturing defects may exhibit measurable swelling or pressure increase minutes to hours before thermal runaway occurs. By detecting such mechanical changes, cell pressure monitor(s) 906 may enable proactive safety responses including pack isolation, cooling activation, fire suppression system arming, or emergency shutdown procedures.

Cell pressure monitor(s) 906 may include bridge amplifiers, instrumentation amplifiers, signal filtering, temperature compensation, and calibration circuits to provide accurate and stable pressure measurements. Pressure measurements may be performed with accuracy of ±1% to ±5% of full scale and resolution sufficient to detect cell swelling of 0.1 mm to 1 mm or pressure changes of 1 kPa to 10 kPa.

Cell balancing controller 908 may include switching circuits, gate driver circuits, current sensing circuits, timing circuits, and protection circuits configured to control the operation of balancing transformers 910 and balancing rectifiers 912. Unlike conventional passive balancing systems that dissipate excess cell energy as heat, or conventional active balancing systems that transfer energy between cells using the battery pack's own stored energy, the cell balancing controller 908 may implement an innovative active balancing approach that uses external grid power as the balancing energy source.

Cell balancing controller 908 may include high-frequency switching circuits operating at frequencies of 50 kHz to 500 kHz or higher to drive balancing transformers 910. The switching circuits may be implemented using MOSFETs, IGBTs, GaN transistors, or SiC transistors capable of high-frequency operation with low switching losses. Gate driver circuits within cell balancing controller 908 may provide isolated gate drive signals, shoot-through protection, dead-time control, and fault protection for the switching devices.

Cell balancing controller 908 may implement pulse-width modulation (PWM), phase-shift control, resonant switching, or other advanced switching techniques to regulate balancing current and minimize electromagnetic interference (EMI). The controller 908 may include current sensing circuits using current transformers, Hall effect sensors, or shunt resistors to monitor balancing current and provide closed-loop current control.

Balancing transformers 910 may represent a key innovation that enables the use of high-frequency AC power for cell balancing while providing galvanic isolation between grid power and battery cells. Each balancing transformer 910 may include a ferrite core, primary winding, and multiple secondary windings configured to step down high-frequency AC voltage from the power supply 804 to appropriate levels for cell balancing.

In some embodiments, balancing transformers 910 may be implemented as multi-output flyback transformers, forward transformers, or resonant transformers with turns ratios selected to provide secondary voltages of 3V to 12V AC or other suitable levels for charging battery cells. Balancing transformers 910 may include multiple secondary windings to support balancing of multiple cells or cell pairs from a single transformer core.

The use of balancing transformers 910 may provide several advantages over conventional balancing approaches. First, the transformers may provide galvanic isolation between the high-voltage grid power source and the battery cells, improving safety and reducing the risk of ground loops or common-mode interference. Second, the transformers may enable efficient voltage conversion from grid voltage levels (100-240V AC) to cell-appropriate voltage levels. Third, the high-frequency operation of the transformers may allow the use of smaller, lighter magnetic components compared to line-frequency transformers.

Balancing transformers 910 may be designed with leakage inductance and magnetizing inductance values selected to support resonant or quasi-resonant operation, thereby reducing switching losses and EMI generation. Balancing transformers 910 may include electrostatic shields, twisted windings, or other techniques to minimize parasitic capacitance and improve isolation performance.

Balancing rectifiers 912 may include diode rectifiers, synchronous rectifiers, or active rectifiers configured to convert the high-frequency AC output of balancing transformers 910 to DC current suitable for charging battery cells. In some embodiments, balancing rectifiers 912 may be implemented using Schottky diodes, fast recovery diodes, or synchronous MOSFETs to minimize forward voltage drop and switching losses.

An innovative aspect of balancing rectifiers 912 may be the implementation of split-phase rectification, where positive and negative half-cycles of the AC balancing power are used to charge different cells. This approach may allow two cells to be balanced simultaneously using opposite phases of the same AC power source, thereby improving balancing efficiency and reducing the number of required transformers and rectifiers.

For example, balancing rectifiers 912 may include a center-tapped rectifier configuration where the positive half-cycle of the AC balancing power is rectified and applied to a first cell, while the negative half-cycle is rectified and applied to a second cell. This may ensure that adjacent cells are never balanced simultaneously, reducing the risk of current loops or interference between balancing circuits.

Balancing rectifiers 912 may include output filtering capacitors, current limiting resistors, or active current regulation circuits to provide smooth DC balancing current to the battery cells. Current regulation may be implemented using linear regulators, switching regulators, or current-mode control techniques to maintain constant balancing current regardless of cell voltage variations.

CANBus communications circuit 914 may include CAN transceiver circuits, isolation circuits, termination circuits, and protocol processing circuits configured to enable communication between MCU 900 and higher-level controllers such as rack controllers, container controllers, or system controllers. The CAN interface may support standard CAN 2.0, CAN-FD (Flexible Data Rate), or other CAN protocol variants with data rates of 125 kbps to 8 Mbps or higher.

In some embodiments, CANBus communications circuit 914 may include galvanic isolation using digital isolators, optocouplers, or magnetic isolators to provide electrical isolation between the battery module controller 640 and external communication networks. This isolation may help prevent ground loops, reduce common-mode noise, and improve system safety by isolating battery-level electronics from system-level electronics.

CANBus communications circuit 914 may support multiple communication modes including broadcast messaging, point-to-point messaging, diagnostic messaging, and emergency messaging. The circuit may implement message filtering, message prioritization, error detection, error correction, and automatic retransmission features to ensure reliable communication in electrically noisy battery system environments.

Connector 916 may be implemented as a ruggedized automotive-grade connector, industrial connector, or custom connector designed to provide reliable electrical connection between the battery module controller 640 and external communication networks. Connector 916 may include multiple pins for CAN high, CAN low, power supply, ground, and auxiliary signals such as enable, fault, or wake-up signals.

In operation, power supply 804 draws power from a power grid and converts this power to higher frequency AC power and DC voltages needed to operate the components of battery module controller 640. The higher frequency AC power output by power supply 804 is supplied to the cell balancing transformers 910 and balancing rectifiers 912 for balancing cells 918. Power supply 804 produces DC power required to operate the various components of battery module controller 640 such as, for example, MCU 900, cell voltage monitors 902, cell temperature monitors 904, cell pressure monitors 906, and cell balancing controller 908. MCU 900 runs the firmware and software that controls the operation and functions of battery module controller 640.

The higher frequency AC power output by power supply 804 may be supplied to the cell balancing transformers 910 and balancing rectifiers 912 for balancing cells 918. This approach may provide several advantages over conventional balancing methods. First, using grid power as the balancing energy source may mean that balancing energy is not taken from the battery cells themselves, allowing balancing to occur at any state of charge and improving overall system efficiency. Second, the high-frequency AC approach may enable the use of smaller, more efficient transformers and allow precise control of balancing current through PWM or other switching techniques.

Power supply 804 may produce DC power required to operate the various components of battery module controller 640 such as, for example, MCU 900, cell voltage monitor(s) 902, cell temperature monitor(s) 904, cell pressure monitor(s) 906, and cell balancing controller 908. The DC power supplies may include switching regulators, linear regulators, or hybrid regulation techniques to provide clean, stable power with low noise and good transient response.

MCU 900 may run the firmware and software that controls the operation and functions of battery module controller 640. These functions may include monitoring the voltage, temperature and pressure of the battery cells that make up the battery module controlled by battery module controller 640. MCU 900 may execute sophisticated algorithms for state-of-charge estimation, state-of-health estimation, remaining useful life prediction, thermal modeling, and predictive maintenance scheduling.

The functions may also include balancing the battery cells of the battery module and communicating data about the battery module and battery cells to a higher-level controller such as, for example, a battery rack controller as described below. MCU 900 may implement advanced balancing algorithms that consider cell voltage, temperature, pressure, state of charge, and aging characteristics to optimize balancing strategies and extend battery life.

Cell voltage monitor(s) 902, cell temperature monitor(s) 904, and cell pressure monitor(s) 906 may be the hardware sensors and circuits needed to monitor the battery cell voltages, temperatures, and pressures. These monitoring circuits may include built-in self-test capabilities, calibration functions, and diagnostic features to ensure measurement accuracy and detect sensor failures.

Cell balancing controller 908 may be the hardware needed to provide balancing current/power to the individual battery cells 918 of the battery module controlled by battery module controller 640. Cell balancing controller 908 may implement intelligent balancing strategies such as top balancing, bottom balancing, continuous balancing, or adaptive balancing based on operating conditions and system requirements.

In an alternative embodiment, battery module controller 640 may implement a distributed balancing architecture where individual cell controllers are positioned adjacent to each battery cell 918. Each cell controller may include local voltage sensing, temperature sensing, pressure sensing, and balancing circuits, with communication to the central MCU 900 through a local area network such as CAN, LIN, or a proprietary communication protocol. This distributed approach may improve scalability, reduce wiring complexity, and enable more precise per-cell control while maintaining the advantages of grid-powered balancing and comprehensive mechanical condition monitoring.

The distributed cell controllers may include local intelligence for autonomous balancing decisions, fault detection, and emergency shutdown capabilities, thereby improving system reliability and safety. Each distributed controller may communicate cell status, balancing progress, and fault information to the central MCU 900, which may aggregate the information and communicate with higher-level system controllers.

This alternative embodiment may be particularly advantageous for very large battery packs with hundreds of cells, where centralized monitoring and balancing may become impractical due to wiring complexity, voltage drop, or electromagnetic interference considerations. The distributed approach may maintain the innovative features of grid-powered balancing and mechanical condition monitoring while providing enhanced scalability and modularity.

FIG. 9B further illustrates an example power supply 804 that can be used with battery module controllers according to an embodiment of the present invention. As shown in FIG. 9B, power supply 804 includes a connector 850, an electromagnetic interference (EMI) filter 852, a rectifier 854, a quasi-resonance power processor 856, isolation transformers 858 and 860, a regulated 5V power circuit 862, a regulated 12V power circuit 864, and one or more DC-to-DC 6V power converter circuits 866 used for battery cell balancing. In embodiments, isolation transformers 858 and 860 can be multiple windings on the same transformer core. Power supply 804 is connected to grid power using connector 850. In one embodiment, quasi-resonance power processor 856 is implemented using an Infineon Technologies 5QR1680AG integrated circuit chip.

Power supply 804 may be configured to receive grid AC power through connector 850, which may be a standard AC power connector, terminal block, or hardwired connection suitable for receiving 100-240 VAC power at 50/60 Hz frequencies. Connector 850 may include appropriate safety features such as strain relief, environmental sealing, overcurrent protection, or ground fault protection to ensure safe connection to grid power sources. In some embodiments, connector 850 may be configured to accept different regional power standards, including North American 120VAC/240VAC systems, European 230 VAC systems, or industrial 480 VAC three-phase systems.

EMI filter 852 may be positioned immediately after connector 850 to reduce electromagnetic interference generated by power supply 804 and to filter incoming grid power to remove noise, transients, or harmonics that could interfere with sensitive battery monitoring and control circuits. EMI filter 852 may include common-mode chokes, differential-mode inductors, X-capacitors, Y-capacitors, surge suppressors, or other filtering components configured to meet applicable EMC standards such as FCC Part 15, CISPR 22, or EN 55022. In some embodiments, EMI filter 852 may also include power factor correction circuitry to improve the power factor of power supply 804 when connected to the grid.

Rectifier 854 may convert the filtered AC grid power to DC power suitable for processing by quasi-resonance power processor 856. Rectifier 854 may be implemented as a full-wave bridge rectifier, center-tap rectifier, or other suitable rectification topology using diodes, synchronous rectifiers, or active rectification circuits. In some embodiments, rectifier 854 may include power factor correction (PFC) circuitry, such as a boost PFC stage, to maintain a high power factor and reduce harmonic distortion when drawing power from the grid. Rectifier 854 may also include bulk capacitors, filtering inductors, or other energy storage and filtering components to provide a stable DC voltage to quasi-resonance power processor 856.

Quasi-resonance power processor 856 may convert the rectified DC power to high-frequency AC power suitable for use with isolation transformer 858 and isolation transformer 860. Quasi-resonance power processor 856 may operate at frequencies significantly higher than the 50/60 Hz grid frequency, such as 50 kHz, 100 kHz, 200 kHz, or other frequencies in the range of 20 kHz to 500 kHz. The higher operating frequency may allow the use of smaller, lighter, and more efficient isolation transformers while providing excellent electrical isolation between the grid power source and the battery cells. In one embodiment, quasi-resonance power processor 856 may be implemented using an Infineon Technologies 5QR1680AG integrated circuit chip, which may provide quasi-resonant flyback control with primary-side regulation, overcurrent protection, overvoltage protection, and thermal shutdown features.

Quasi-resonance power processor 856 may include switching elements such as MOSFETs, IGBTs, or other power semiconductor devices that may switch at the high frequency to create the high-frequency AC power. The switching may be controlled using pulse-width modulation (PWM), frequency modulation, phase-shift control, or other switching control techniques to regulate output voltage and current. In some embodiments, quasi-resonance power processor 856 may include feedback circuits, error amplifiers, compensation networks, or digital control circuits to maintain stable output regulation under varying load conditions.

Isolation transformer 858 and isolation transformer 860 may provide electrical isolation between the grid power source and the battery module controller circuits while stepping down the high-frequency AC power to appropriate voltage levels for the various DC output circuits. Isolation transformer 858 and isolation transformer 860 may be implemented as separate transformer assemblies or as multiple windings on a common transformer core. The transformers may include primary windings connected to quasi-resonance power processor 856 and multiple secondary windings configured to provide different output voltage levels.

In some embodiments, isolation transformer 858 may be configured to provide power for regulated 5Vdc circuit 862 and regulated 12Vdc circuit 864, while isolation transformer 860 may be configured to provide power for DC-DC converters 6Vdc (cell balancing) 866 used for battery cell balancing. Isolation transformer 858 and isolation transformer 860 may include appropriate turns ratios to step down the high-frequency AC power from quasi-resonance power processor 856 to voltage levels suitable for the downstream rectification and regulation circuits.

Isolation transformer 858 and isolation transformer 860 may be designed to provide high isolation voltage ratings, such as 1500VAC, 2500VAC, 4000VAC, or higher, to ensure safe isolation between grid power and battery circuits. The transformers may include appropriate insulation materials, creepage distances, clearance distances, and construction techniques to meet safety standards such as UL 1950, IEC 60950, UL 2089, or IEC 62368. In some embodiments, the transformers may include electrostatic shields, multiple insulation layers, or other features to enhance isolation performance and reduce common-mode noise coupling.

Regulated 5Vdc circuit 862 may receive high-frequency AC power from isolation transformer 858, rectify the AC power to DC, and regulate the DC voltage to provide a stable 5VDC output for powering digital circuits, microcontrollers, communication circuits, sensors, and other low-power components within battery module controller 640. Regulated 5Vdc circuit 862 may include rectifier diodes, filter capacitors, voltage regulator circuits, current limiting circuits, overvoltage protection circuits, and thermal protection circuits. In some embodiments, regulated 5Vdc circuit 862 may be implemented using linear regulators, switching regulators, low-dropout (LDO) regulators, or other voltage regulation topologies to provide clean, stable power with low noise and good transient response.

Regulated 12Vdc circuit 864 may similarly receive high-frequency AC power from isolation transformer 858, rectify the AC power to DC, and regulate the DC voltage to provide a stable 12VDC output for powering analog circuits, operational amplifiers, sensor excitation circuits, relay drivers, contactor drivers, cooling fans, or other components that may require higher voltage levels than the 5V circuits. Regulated 12Vdc circuit 864 may include similar rectification, filtering, regulation, and protection circuits as regulated 5Vdc circuit 862, but configured for the higher output voltage level.

DC-DC converters 6Vdc (cell balancing) 866 may be specifically configured to provide power for battery cell balancing operations. These circuits may receive high-frequency AC power from isolation transformer 860, rectify the AC power, and convert it to approximately 6VDC or other voltage levels suitable for charging individual battery cells during balancing operations. In some embodiments, multiple DC-DC converters 6Vdc (cell balancing) 866 may be provided, with each circuit dedicated to balancing specific cells or cell groups within the battery module.

DC-DC converters 6Vdc (cell balancing) 866 may include current limiting, voltage regulation, thermal protection, and fault detection features to ensure safe and controlled delivery of balancing power to individual battery cells. The circuits may be designed to provide balancing currents in the range of 100 mA to 2 A per cell, depending on the cell capacity, balancing requirements, and thermal constraints. In some embodiments, the balancing power may be delivered as pulsed current, constant current, constant voltage, or other charging profiles optimized for the specific battery cell chemistry and balancing strategy.

Power supply 804 may also include various protection and monitoring circuits, such as overvoltage protection, undervoltage lockout, overcurrent protection, overtemperature protection, short-circuit protection, and fault detection circuits. These protection circuits may monitor the input power, intermediate power stages, and output power circuits to detect abnormal conditions and safely shut down or limit the power supply operation to prevent damage to power supply 804 or connected battery module controller circuits.

In some embodiments, power supply 804 may include communication interfaces, status indicators, diagnostic circuits, or remote monitoring capabilities that may allow the power supply status, operating parameters, fault conditions, or performance metrics to be monitored by battery module controller 640 or external systems. Power supply 804 may communicate power supply status, input voltage, output voltages, output currents, operating temperature, efficiency, or fault codes to assist with system diagnostics, maintenance, and optimization.

Power supply 804 may be designed for high efficiency operation, such as 85%, 90%, 95%, or higher efficiency, to minimize heat generation and reduce cooling requirements within battery module controller 640. High efficiency operation may be achieved through the use of synchronous rectification, soft switching techniques, optimized magnetic components, low-loss semiconductor devices, and advanced control algorithms.

In an alternative embodiment, power supply 804 may be implemented using a different topology, such as a forward converter, half-bridge converter, full-bridge converter, LLC resonant converter, or other isolated switching power supply topology. The alternative topology may be selected based on power requirements, efficiency targets, size constraints, cost considerations, or other design criteria specific to the battery module controller application. For example, an LLC resonant converter topology may provide higher efficiency and lower electromagnetic interference compared to the quasi-resonant flyback topology, particularly for higher power applications.

In another alternative embodiment, power supply 804 may include multiple isolated outputs with independent regulation and protection for different functional circuits within battery module controller 640. For instance, separate isolated outputs may be provided for digital circuits, analog circuits, communication circuits, sensor circuits, and balancing circuits to improve noise isolation, fault isolation, and system reliability. Each isolated output may include its own rectification, filtering, regulation, and protection circuits tailored to the specific requirements of the connected circuits.

The modular design of power supply 804 may allow for scalability and customization based on the specific requirements of different battery module controller configurations. For example, the number of DC-DC converters 6Vdc (cell balancing) 866 may be varied based on the number of battery cells to be balanced, the balancing current requirements, or the desired level of balancing circuit redundancy. Similarly, the power ratings of regulated 5Vdc circuit 862 and regulated 12Vdc circuit 864 may be adjusted based on the power consumption of the connected control and monitoring circuits.

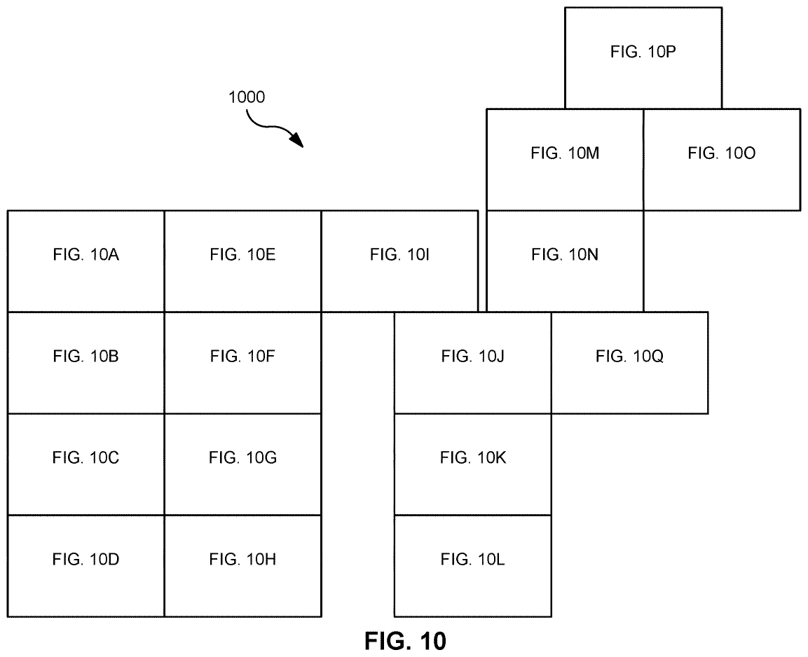

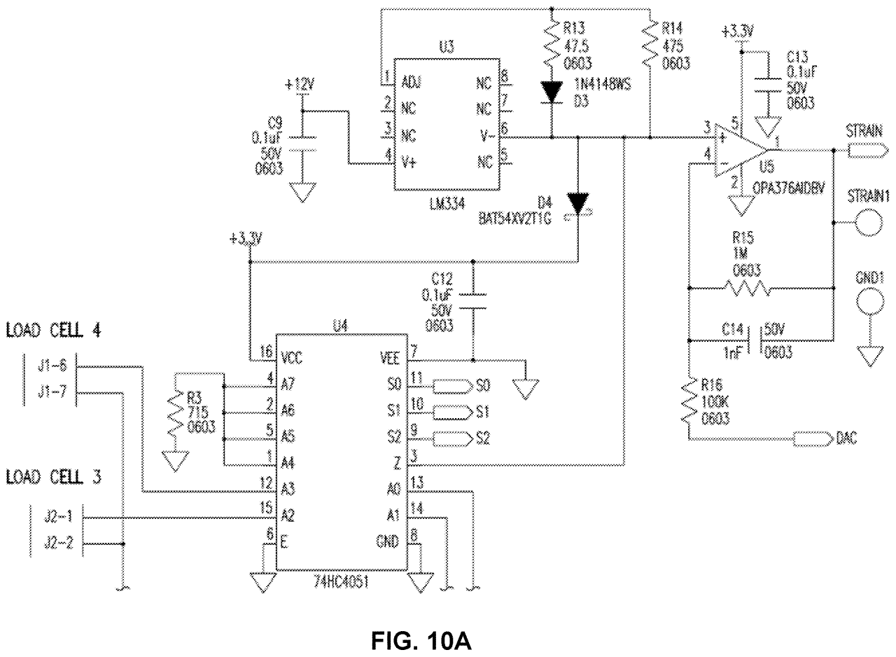

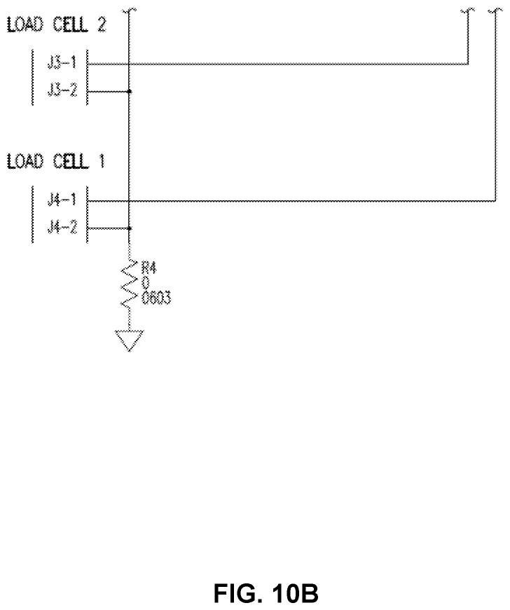

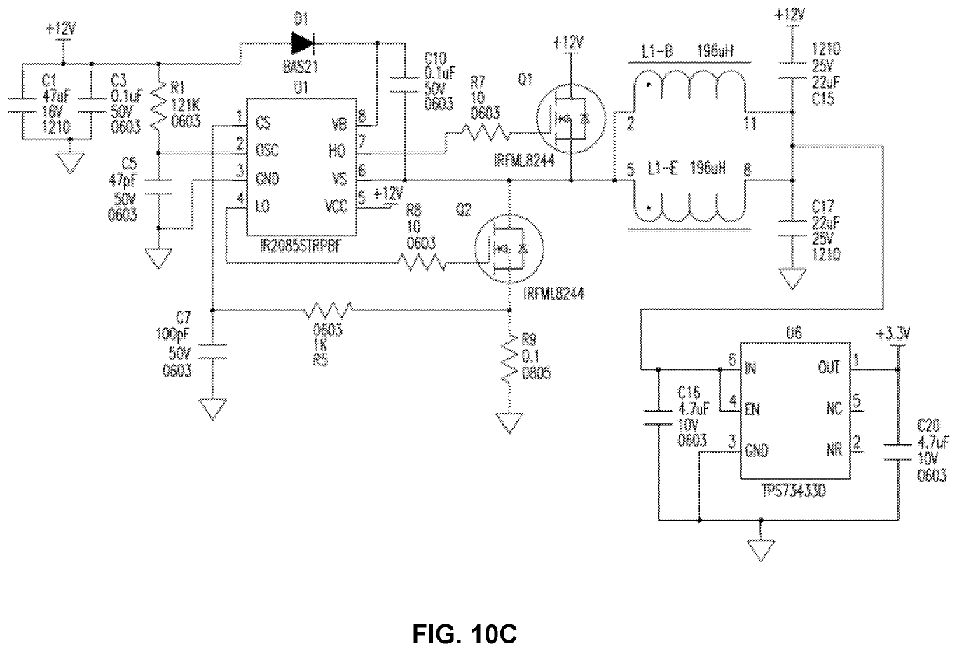

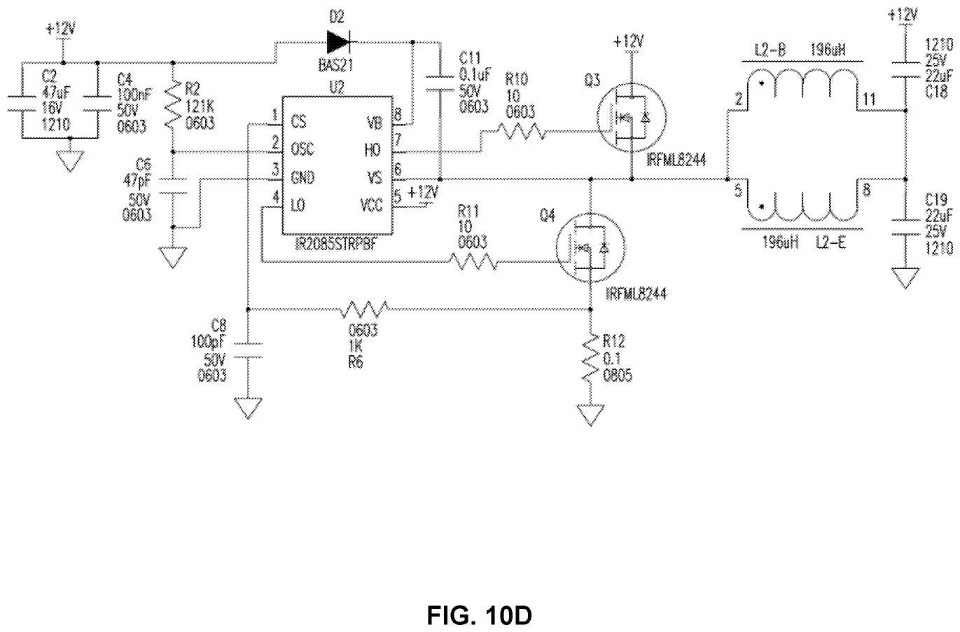

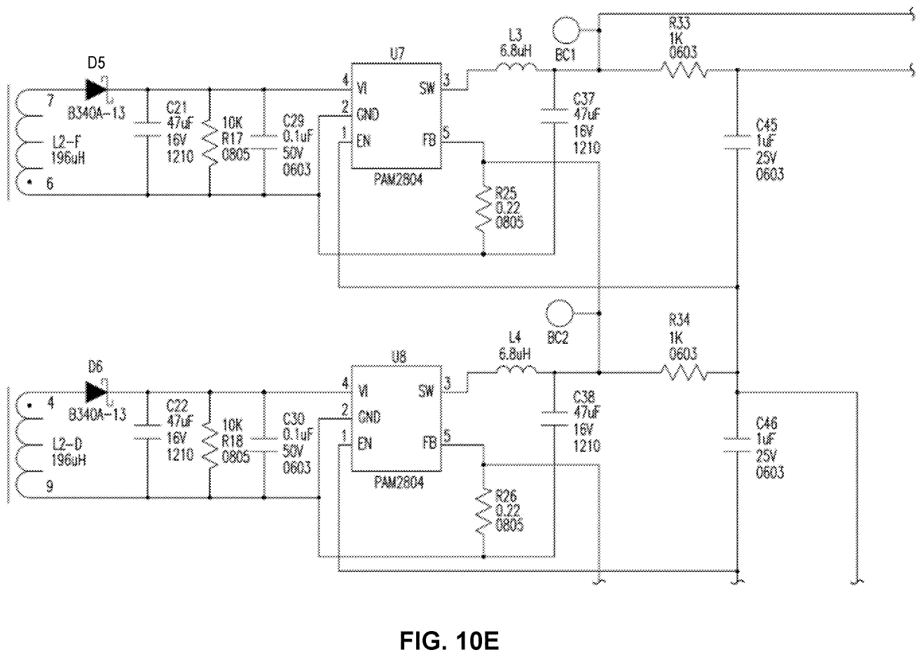

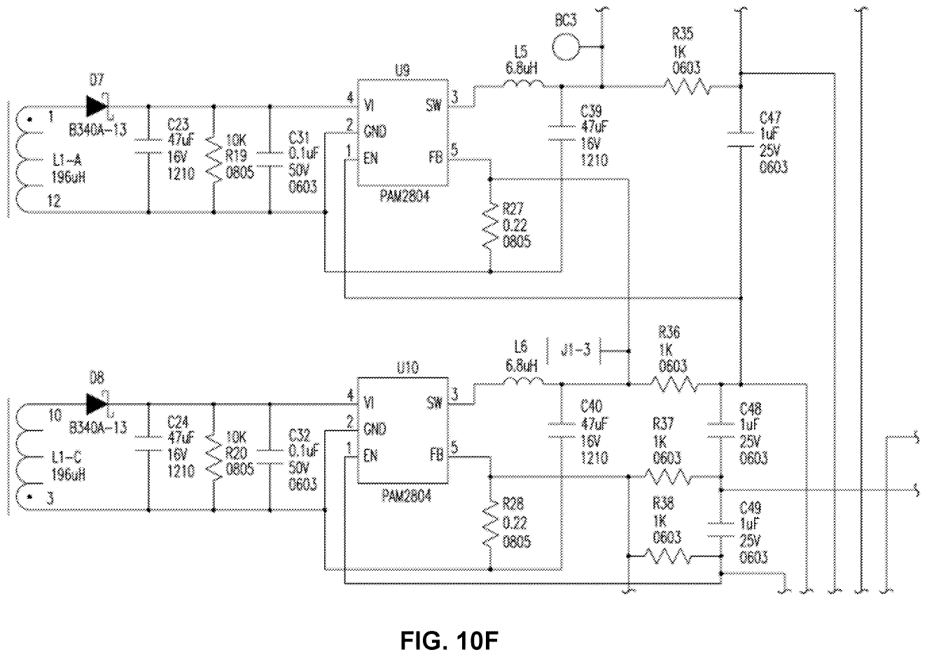

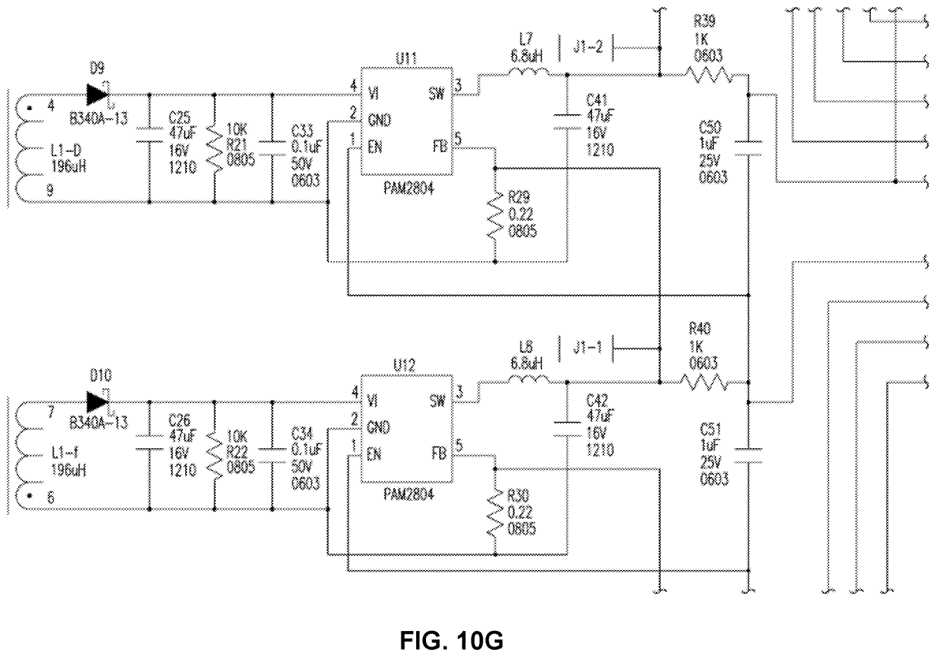

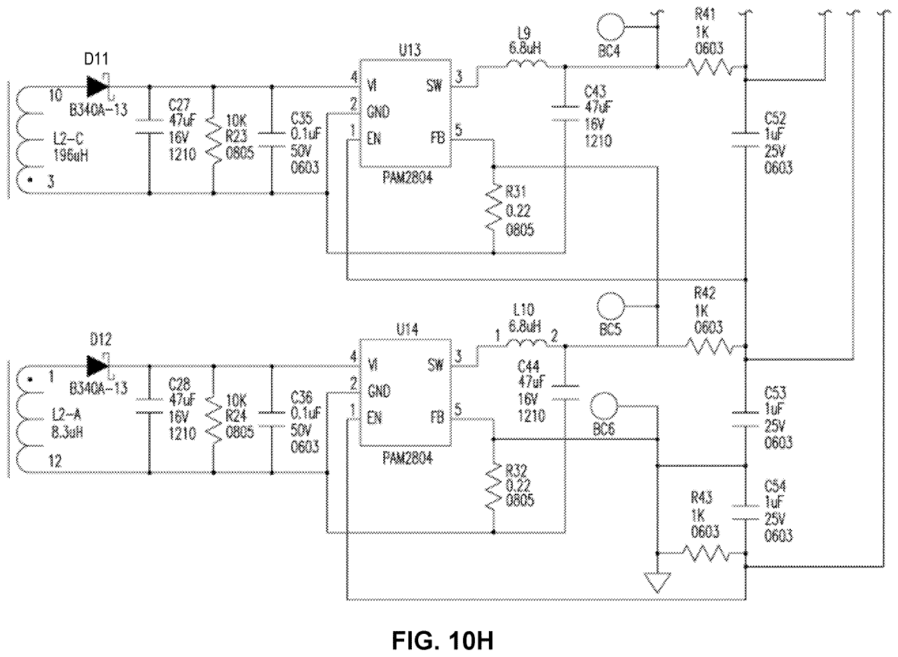

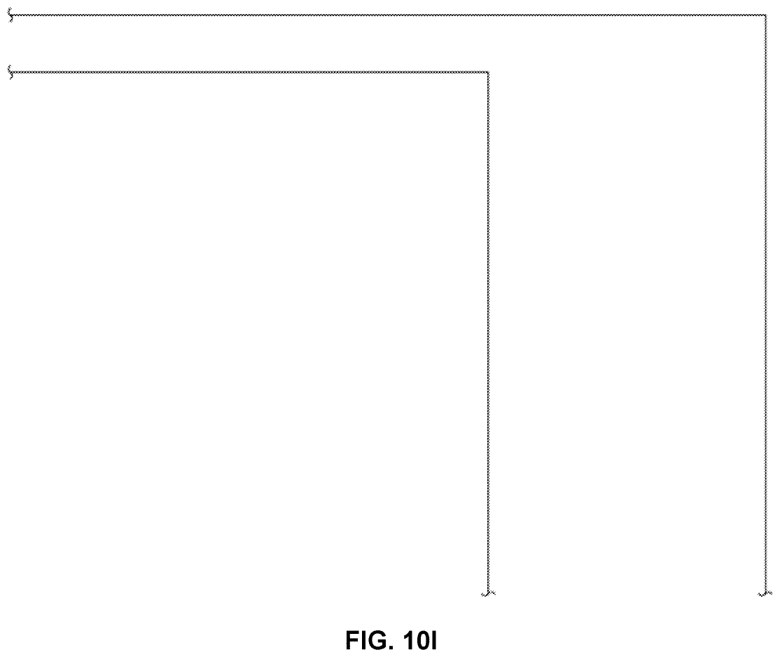

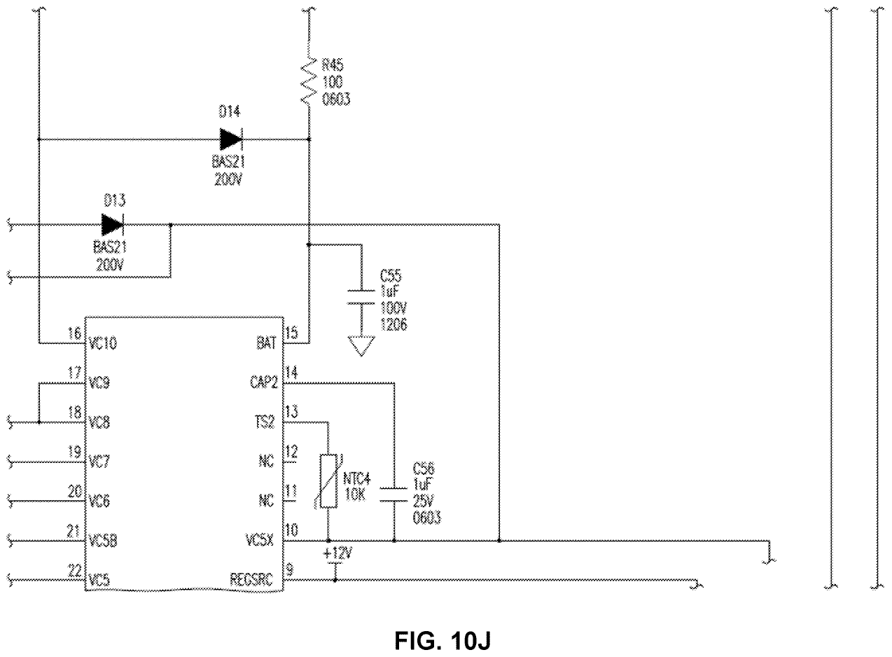

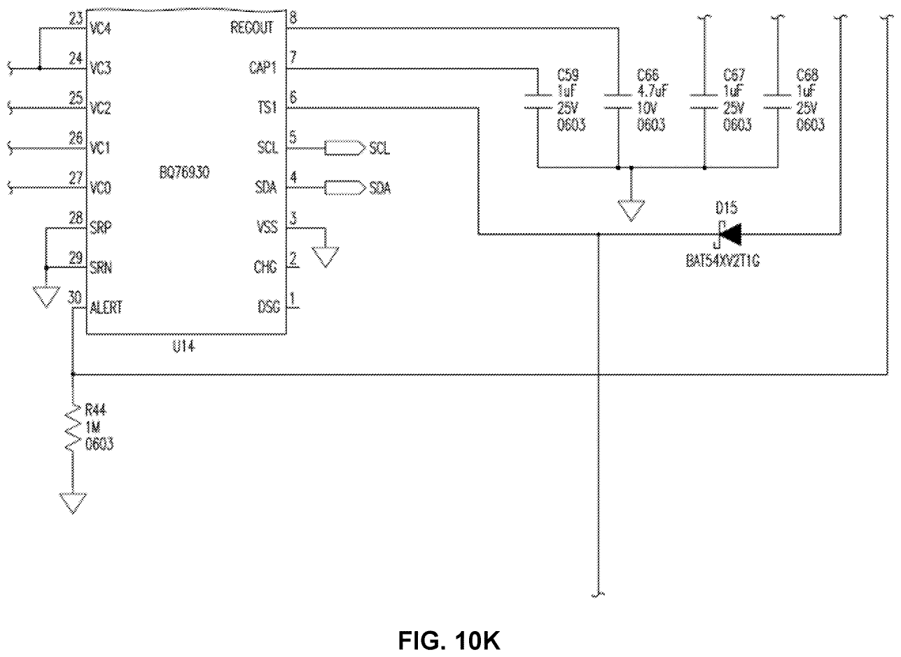

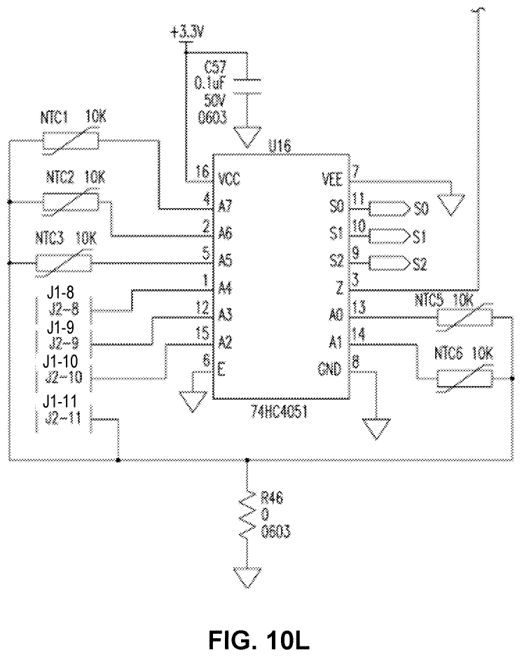

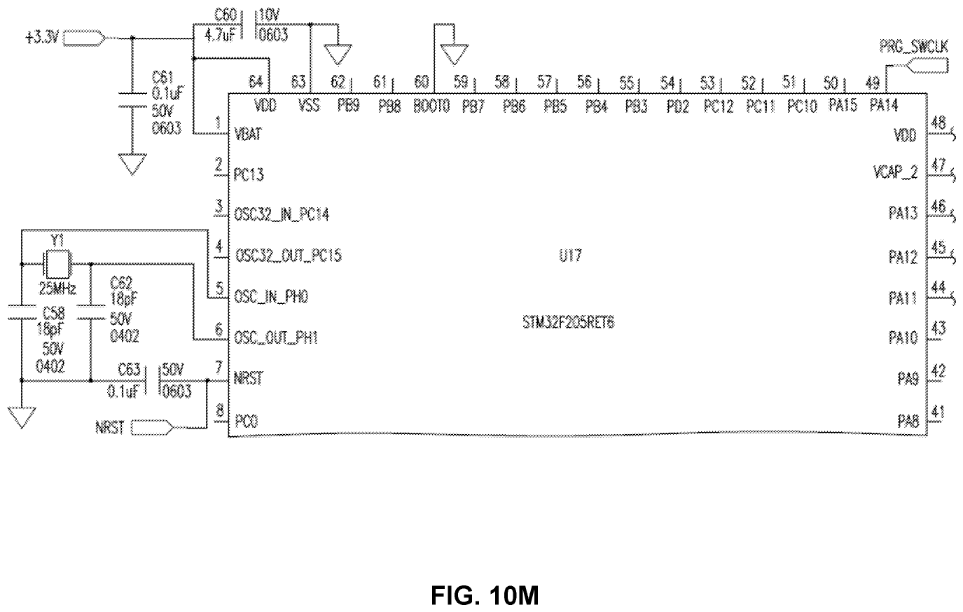

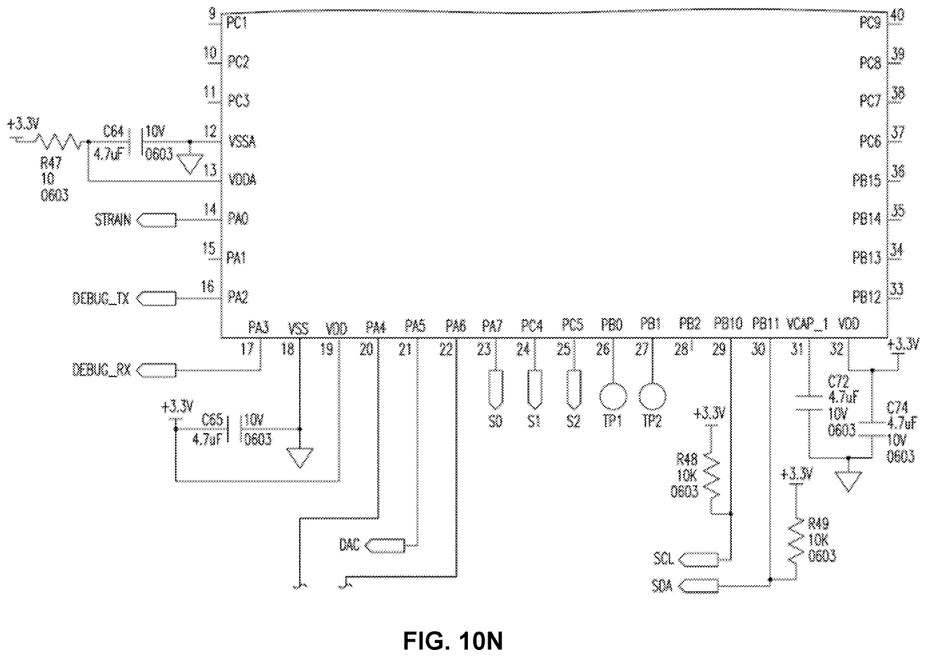

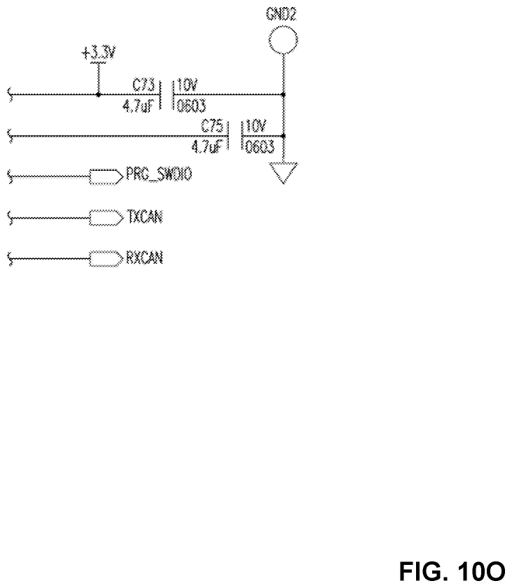

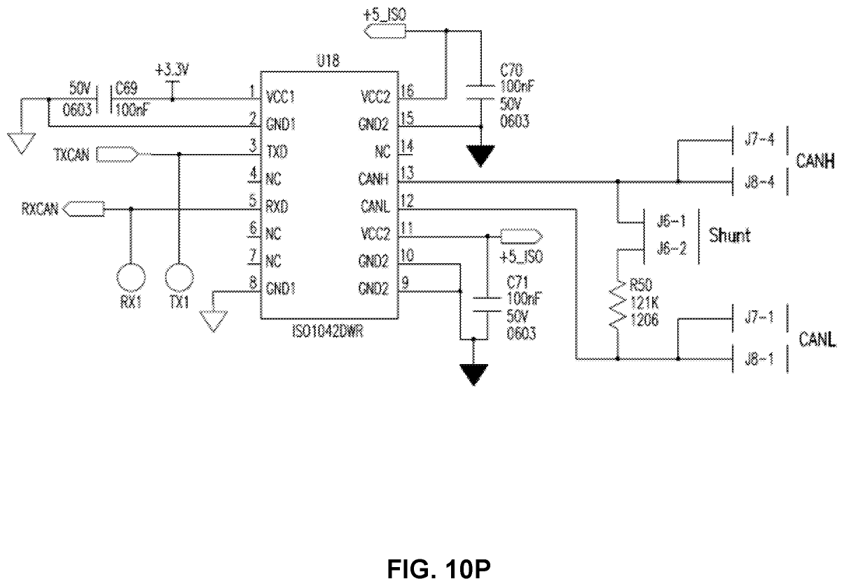

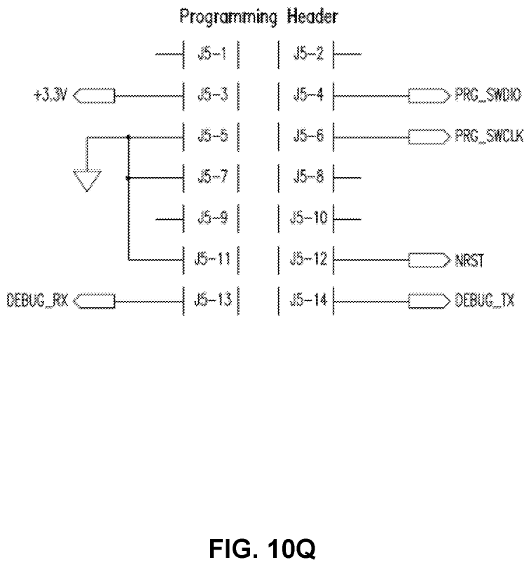

FIGS. 10 and 10A-Q illustrate a detailed circuit diagram for battery module controller 640 according to an embodiment of the present invention. As shown in FIGS. 10A-Q, in an embodiment, two convertors each drive a transformer that create a selected number of isolated outputs each. These isolated outputs are used with a constant current circuit to charge battery cells in the battery module. Each of the battery cells is monitored for temperature. The circuit is controlled by a microprocessor and communicates to a higher-level controller using CANBus communications. The microprocessor also measures the voltage on each battery cell. The controller also includes circuits that measure the swelling/pressure of the battery cells.

In one embodiment, the disclosed circuit comprises a battery module monitoring and control circuit 802 configured for use with a multi-cell battery pack 202 and BESS DC block 100. Circuit 802 is configured to monitor or received data about battery cell voltages, battery current, temperature sensors, mechanical strain or load sensors, and communication signals, and to control one or more safety, balancing, relay, and communication functions associated with battery pack 202.

Circuit 802 includes an microcontroller unit (MCU) 900, a plurality of cell-interface circuits comprising cell balancing transformers 910 and balancing rectifiers 912, an active balancing or cell energy transfer circuit 908, temperature sensing circuitry 904, strain or load sensing circuitry 906, isolated communication circuitry 914, relay driver circuitry (not shown), and one or more isolated or regulated power supplies 804. Circuit 802 may be mounted on a main battery management system board 700 and may communicate with one or more auxiliary boards, external controllers, or higher-level battery system controllers.

The battery monitoring section includes a multi-cell battery monitor circuit configured to measure voltages of a plurality of series-connected battery cells. In the illustrated embodiment, the battery monitor is implemented using a battery monitor integrated circuit having cell voltage input terminals corresponding to a plurality of cell tap connections. The cell tap inputs are connected through filtering, protection, and current-limiting components to battery cell nodes identified in the schematic as main and auxiliary cell connections.

The battery monitor circuit is configured to measure individual cell voltages, detect over-voltage and under-voltage conditions, monitor pack or module current through shunt sense inputs, and provide fault or alert signals to a system controller. The monitor circuit may include terminals for charge control, discharge control, temperature sensing, current sense inputs, communication lines, and an alert output. In the illustrated embodiment, the battery monitor communicates with the microcontroller through an I²C-style interface including serial data and serial clock conductors.

The battery monitor may be used to determine cell voltage imbalance, battery state conditions, fault conditions, and safety status. In response to detected voltage, current, or temperature conditions, the controller may initiate balancing, disable charging, disable discharging, open a relay, communicate a fault condition, or place the battery module into a safe operating mode.

Circuit 802 includes a MCU 900 configured to coordinate operation of the battery monitoring, balancing, sensing, communication, and relay-control functions. In the illustrated embodiment, the controller is an STM32-type microcontroller having analog inputs, digital control outputs, serial communication interfaces, programming pins, reset circuitry, clock circuitry, and power supply decoupling.

MCU 900 receives battery information from the battery module monitor circuit, receives analog sensor signals from multiplexed strain and temperature sensing circuits, controls address lines for analog multiplexers, controls relay driver circuitry, and communicates battery information to external systems through an isolated CAN interface. MCU 900 may execute firmware configured to periodically measure cell voltages, read sensor values, compare measured values to safety thresholds, determine whether balancing is required, control balancing energy transfer, and report operating conditions to an external battery system controller.

Circuit board 700 may store calibration data, sensor offset data, load-cell scaling factors, temperature coefficients, balancing thresholds, fault limits, and communication identifiers. The controller may further include diagnostic routines for detecting open sensor connections, abnormal cell voltage readings, communication faults, relay faults, or power supply faults.

Circuit board 700 includes an active balancing controller 908 configured to transfer energy to or among selected battery cell nodes. In the illustrated embodiment, the balancing section includes oscillator or gate-driver circuits, switching transistors, magnetic elements, rectifier diodes, switching regulator circuits, inductors, capacitors, and current-sense or current-limiting resistors.

A first switching circuit includes a driver circuit coupled to a pair of MOSFET switching devices and to windings of a magnetic element. A second similar switching circuit is also provided. These switching circuits may generate alternating or pulsed energy in respective magnetic windings. The magnetic elements include multiple windings that distribute energy to a plurality of isolated or semi-isolated balancing channels.

Each balancing channel may include a rectifier diode, input and output capacitors, an inductor, a switching regulator, and a current-sense element. The switching regulator associated with each channel may regulate a balancing current delivered to a corresponding battery cell node or cell group. In the illustrated embodiment, a plurality of regulator circuits are connected to respective main and auxiliary cell nodes, thereby enabling balancing energy to be applied to selected cells or selected portions of the battery stack.

The balancing section may operate by energizing one or more magnetic windings from a low-voltage supply and delivering regulated current into selected cell terminals. This allows the controller to correct cell imbalance without relying solely on passive resistive dissipation. In some embodiments, the balancing circuit may be controlled to charge lower-voltage cells, reduce voltage spread among cells, maintain cell voltage uniformity during charging, or improve pack usable capacity and service life.

In some embodiments, balancing may be initiated when the difference between a highest measured cell voltage and a lowest measured cell voltage exceeds a predetermined threshold. The microcontroller may determine which cell or cells require balancing based on voltage measurements from the battery monitor circuit and may enable one or more balancing channels accordingly. Balancing may be suspended or disabled if a cell voltage exceeds a maximum limit, if a temperature exceeds a temperature limit, if pack current exceeds a threshold, if communication is lost, or if another safety fault is detected.

Circuit board 700 includes a temperature sensing section 904 having a plurality of thermistor inputs. In the illustrated embodiment, one or more negative temperature coefficient thermistors are connected to an analog multiplexer. The multiplexer is controlled by address lines from the microcontroller and allows multiple temperature sensors to share a common analog measurement path.

The temperature sensing circuit may be used to measure cell temperature, module temperature, board temperature, connector temperature, coolant temperature, or other battery system temperatures. The controller may convert measured thermistor voltages into temperature values using calibration data or lookup tables. The measured temperatures may be used to limit charging, limit discharging, disable balancing, operate thermal management equipment, issue warnings, or trigger a fault response.

In embodiments, circuit board 700 further includes an optional strain or load-cell sensing section connected to a plurality of load-cell inputs. The load-cell input lines are coupled to analog multiplexer circuits, allowing the controller to select among multiple load-cell channels using shared address lines.

A current source, diode network, analog multiplexer, and operational amplifier are arranged to excite and measure selected load-cell or strain-sensing elements. The selected sensor signal is buffered or amplified by an operational amplifier and provided to an analog input of the microcontroller as a strain signal.

The strain or load-cell section may be used to detect mechanical compression, swelling, pressure, clamping force, module expansion, enclosure deformation, or other mechanical conditions associated with the battery module. This information may be used as an additional safety input. For example, abnormal strain or pressure may indicate cell swelling, mechanical damage, improper module assembly, thermal runaway precursor conditions, or failure of a compression structure. The controller may compare measured strain values against stored thresholds and may generate warnings, limit operation, disable charge or discharge, or communicate a fault condition.

Circuit board 700 includes an isolated CAN communication interface. The microcontroller transmits and receives CAN data through logic-level transmit and receive lines connected to an isolated CAN transceiver. The isolated transceiver provides galvanic isolation between the microcontroller side of the circuit and the external CAN bus side.

The CAN interface may include CANH and CANL bus connections, termination resistance, isolated power, and signal isolation. The isolated interface reduces the risk that high common-mode voltages, ground potential differences, transient events, or external wiring faults will damage the controller or corrupt measurements. The CAN interface allows the board to communicate cell voltages, current, temperature, strain, balancing status, relay status, diagnostic information, and fault codes to a master BMS, inverter, charger, battery rack controller, or energy storage system controller.

The circuit includes relay driver circuitry configured to energize or de-energize a relay or other controlled device. In the illustrated embodiment, a relay coil is driven by a MOSFET controlled by a relay signal from the microcontroller. A diode is connected across the relay coil to suppress inductive voltage transients when the relay is switched off.

The relay may be used to enable or disable an auxiliary circuit, isolate a battery circuit, control precharge, enable a power supply, actuate a safety disconnect, or control another battery system function. The controller may open or close the relay based on cell voltage, pack current, temperature, strain, communication status, balancing status, or detected fault conditions.

Circuit board 700 includes a power supply section configured to generate regulated low-voltage rails from a higher-voltage or auxiliary input. In the illustrated embodiment, the power supply section includes input protection, a fuse, common-mode filtering, capacitors, a rectifier bridge, a bulk storage capacitor, a switching power controller, a transformer, secondary rectification, optocoupler feedback, a voltage reference, and linear or switching regulators.

The power supply may generate a regulated 12 V rail, an isolated 5 V rail, and a regulated 3.3 V rail. The 12 V rail may power relay circuitry, balancing drivers, and other intermediate circuits. The isolated 5 V rail may power the isolated side of the CAN interface. The 3.3 V rail may power the microcontroller, analog multiplexers, and logic-level circuits.

The isolated power supply allows the control electronics and communication circuitry to operate safely in a battery module environment where large voltage differences and transient events may occur. The use of isolated feedback through optocouplers allows the secondary output voltage to be regulated while maintaining galvanic isolation between primary and secondary portions of the power supply.

The circuit includes a programming header connected to microcontroller programming and diagnostic signals. The programming header may include power, ground, reset, serial wire debug clock, serial wire data, and debug transmit/receive signals. The header may be used during manufacturing, firmware loading, calibration, testing, troubleshooting, or field service.

The controller may support firmware updates, calibration procedures, diagnostic logging, sensor verification, balancing tests, CAN communication tests, and production end-of-line testing through the programming interface.

During operation, the power supply generates regulated operating voltages for the controller, battery monitor, sensor circuits, balancing circuits, relay circuits, and communication interface. The microcontroller initializes the battery monitor, configures communication interfaces, selects sensor channels, and periodically acquires battery data.

The battery monitor measures cell voltages and current-related signals. The microcontroller reads the measured values and determines whether the battery module is operating within allowable limits. The controller also selects temperature and strain sensor channels using multiplexer address lines and measures the corresponding analog signals.

If the controller detects that one or more cells require balancing, the controller may activate the active balancing circuit to transfer controlled energy to selected cell nodes. If the controller detects an unsafe condition, such as over-voltage, under-voltage, over-temperature, abnormal strain, over-current, communication loss, or internal fault, the controller may disable balancing, open a relay, issue a CAN fault message, or otherwise place the battery module into a safe state.

The circuit therefore provides an integrated battery module management function that combines electrical monitoring, active balancing, mechanical condition sensing, thermal monitoring, isolated communication, relay control, and isolated power conversion on a common main board.

The disclosed circuit may provide one or more of the following advantages:
Integrated cell and module monitoring using cell voltage, current, temperature, and mechanical strain inputs.
Active balancing capability that can transfer controlled balancing energy through magnetic and regulator-based channels rather than relying only on passive bleed resistors.
Improved safety monitoring by combining electrical, thermal, and mechanical indicators of battery condition.
Reduced wiring complexity through multiplexed temperature and load-cell sensing.
Improved communication robustness through galvanically isolated CAN communication.
Improved serviceability and manufacturing support through programming and diagnostic access.
Fault-responsive control through microcontroller-supervised relay actuation, balancing control, and external fault reporting.

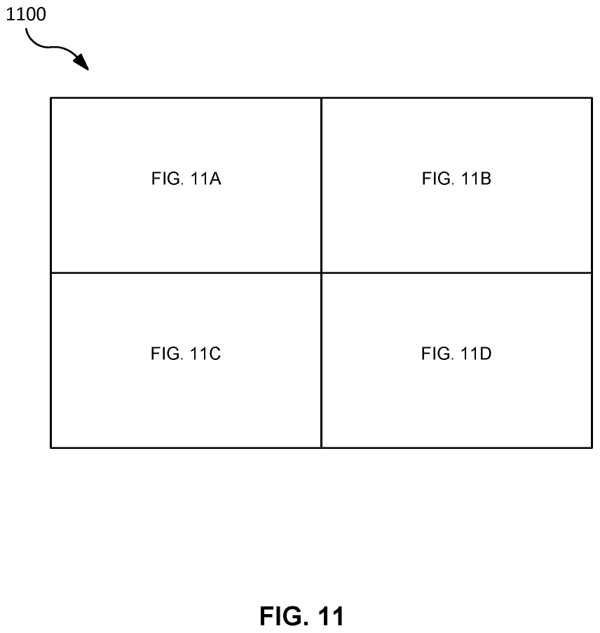

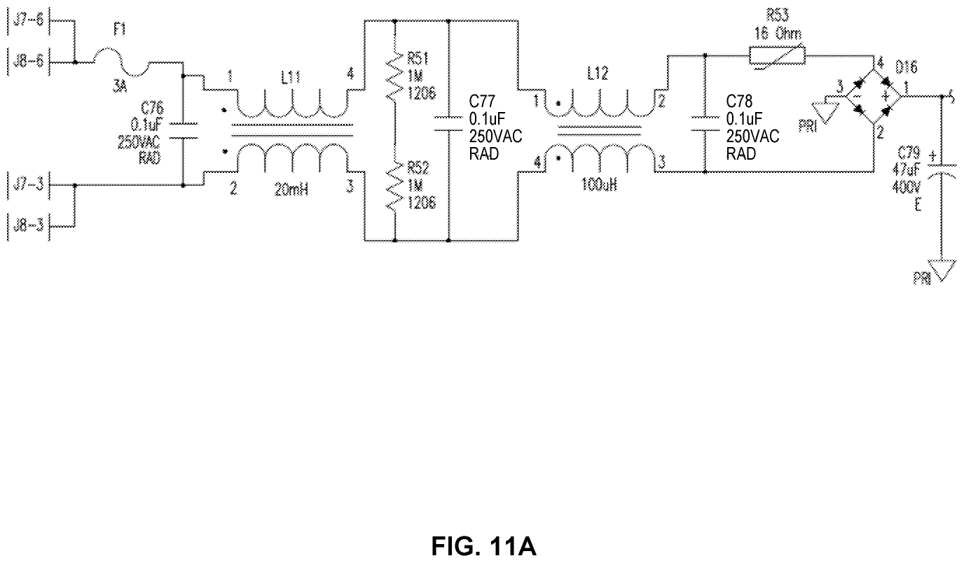

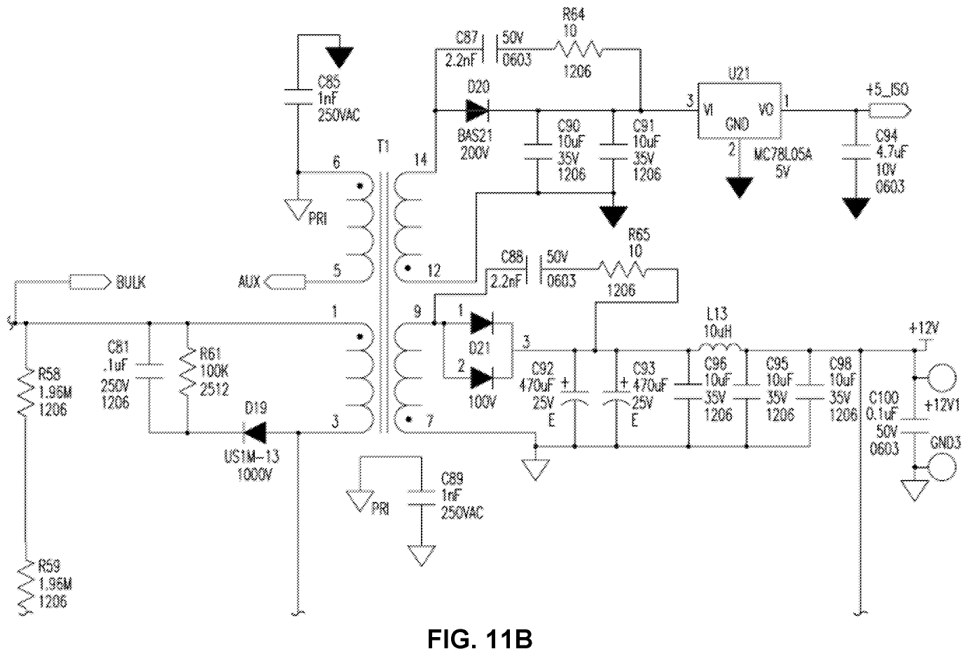

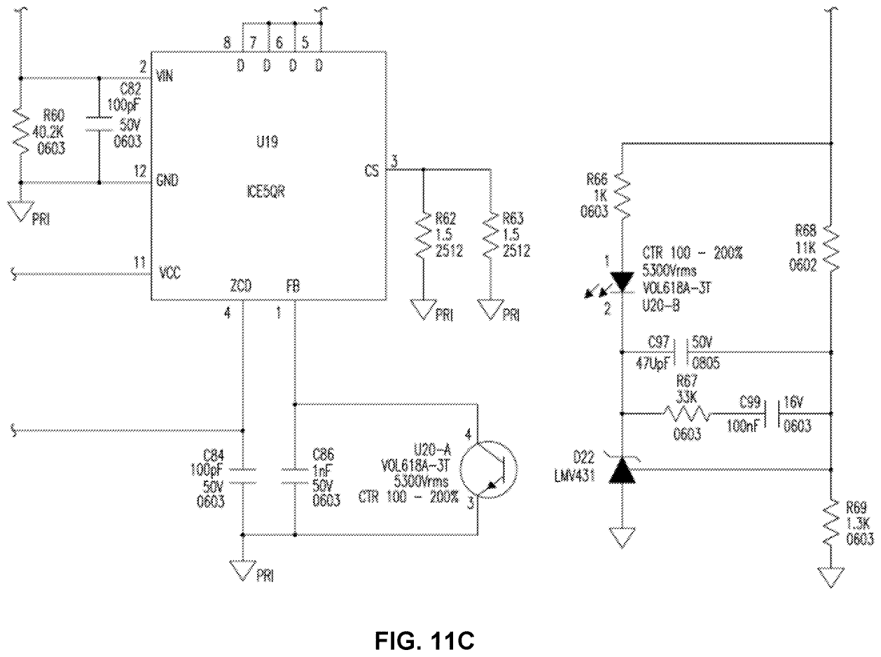

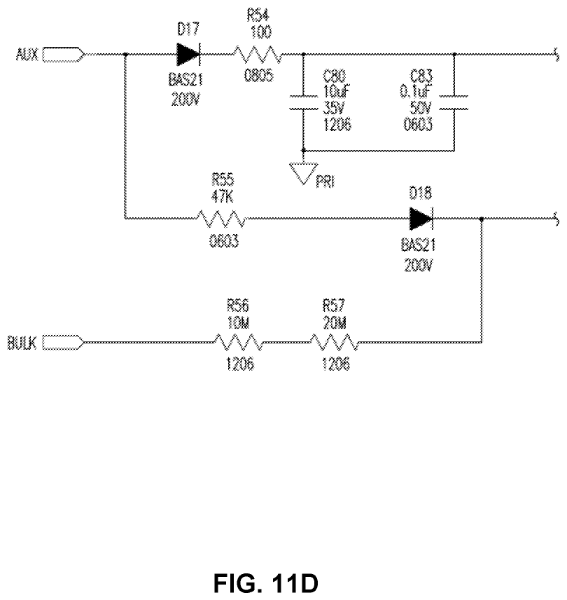

FIGS. 11 and 11A-D show a detailed circuit diagram for power supply 804 according to an embodiment of the present invention. As shown in FIGS. 11A-D, power supply 804 includes a universal 100V-240V, 50 Hz/60 Hz input with circuits to limit EMI and inrush current. It also includes an off-line quasi-resonant switch mode power supply. AC power is supplied to a connector and passes through a fuse and the EMI filter. The input voltage is then rectified and stored on a capacitor. The power supply controller causes energy to be stored as magnetic flux in the transformer where it is intermittently removed by two isolated output diodes. In an embodiment, the power supply circuit produces +5V and +12V that are dielectrically isolated from each other as well as the input. An optocoupler is used to sense and regulate the output voltage.

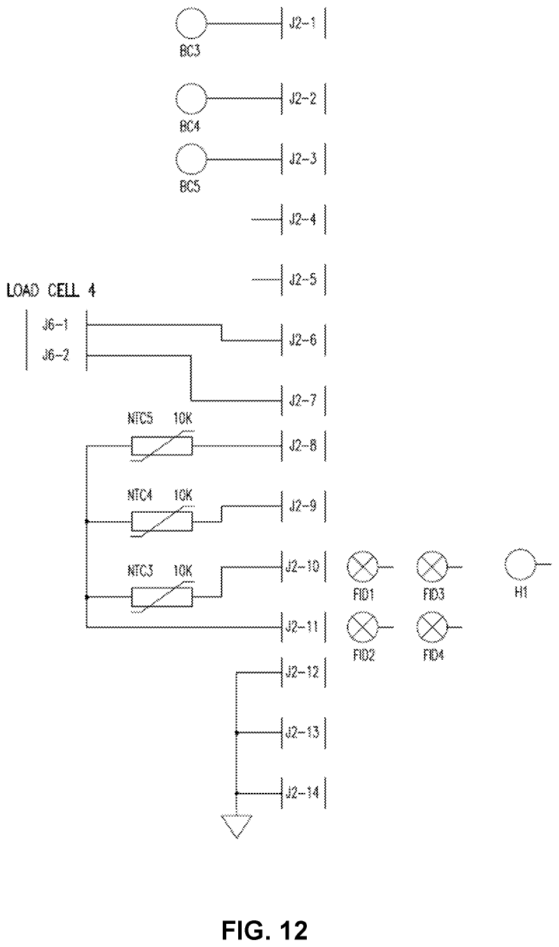

FIG. 12 illustrates an example connector for a battery module controller according to an embodiment of the present invention. In embodiments, it is used for example as can be seen in FIG. 8 to connect circuits on a circuit board 700 to cells 504 and sensors in battery pack 202 such as temperature sensors and pressure sensors.

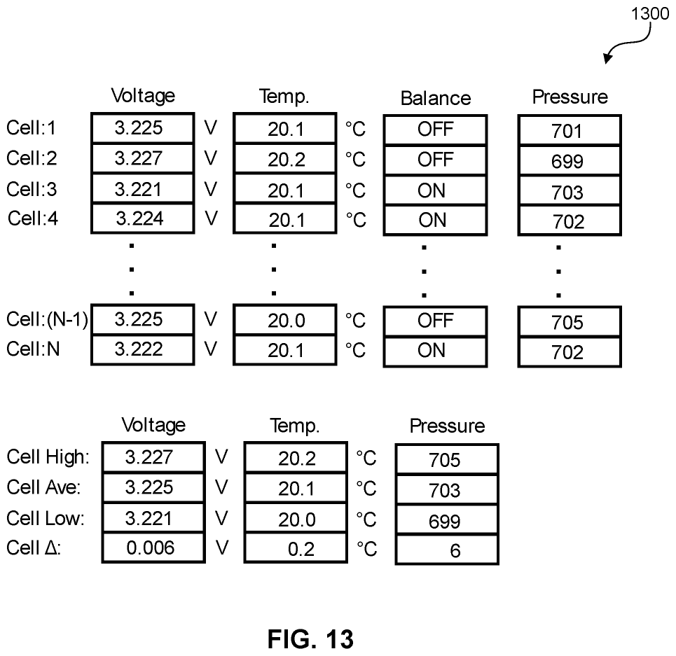

FIG. 13 illustrates an example battery module controller graphical user interface (“GUI”) 1300 according to an embodiment of the present invention. The GUI 1300 may display data generated by firmware and/or software running on one or more battery module controllers described herein, including, for example, the battery module controller 640. The GUI 1300 may be displayed on a computer, tablet, service tool, commissioning device, rack-level controller, container-level controller, remote monitoring system, or other user interface device.

In the illustrated embodiment, the GUI 1300 presents cell-level operating information for a plurality of cells identified as Cell:1 through Cell:N. For each cell, the GUI 1300 may display a measured cell voltage, a measured temperature, a balancing status, and a pressure or mechanical loading value. The displayed values may be obtained directly from the battery module controller 640, calculated by firmware running on the battery module controller 640, or transmitted from the battery module controller 640 to a higher-level monitoring system.

The voltage column may display individual cell voltages measured by the battery module controller 640 or by a battery monitoring circuit associated with the battery module controller 640. The voltage values may be used to determine cell imbalance, over-voltage conditions, under-voltage conditions, state of charge, balancing requirements, and other operating conditions of the battery pack 202.

The temperature column may display temperatures associated with individual cells, cell groups, module locations, sensors, or thermistors. The temperature values may be used by the firmware to determine whether charging, discharging, or balancing should be enabled, limited, or disabled. The temperature values may also be used to detect abnormal thermal conditions within the battery pack 202.

The balance column may display a balancing state for each cell or cell group. In the example shown, the balance state may be represented as ON or OFF. An ON state may indicate that the battery module controller 640 has enabled balancing for a corresponding cell or cell group, while an OFF state may indicate that balancing is disabled for that cell or cell group. The balancing status may be determined based on voltage spread, cell voltage thresholds, temperature limits, pack current, operating mode, or other control logic executed by the firmware.

The pressure column may display pressure, compression, strain, load, force, swelling, or other mechanical-condition values associated with corresponding cells or cell groups. In some embodiments, the pressure values may be derived from load cells, strain gauges, pressure sensors, compression sensors, or other mechanical sensors positioned within or adjacent to the battery pack 202. The pressure values may be used to detect abnormal cell expansion, improper compression, mechanical damage, enclosure deformation, thermal runaway precursor conditions, or other battery pack safety conditions.

The GUI 1300 may also include summary data calculated from the individual cell-level values. As shown in FIG. 13, the GUI 1300 may display a high value, average value, low value, and delta value for voltage, temperature, and pressure. For example, the GUI 1300 may display a highest cell voltage, an average cell voltage, a lowest cell voltage, and a voltage difference between the highest and lowest cell voltages. Similarly, the GUI 1300 may display highest, average, lowest, and delta temperature values, as well as highest, average, lowest, and delta pressure values.

The summary data may allow a user, technician, commissioning engineer, operator, or remote monitoring system to quickly determine whether the battery pack 202 is operating within acceptable limits. A high voltage delta may indicate cell imbalance. A high temperature delta may indicate localized heating or cooling-system malfunction. A high pressure delta may indicate uneven compression, cell swelling, mechanical stress, or other abnormal mechanical condition.

In some embodiments, the GUI 1300 may be used during manufacturing, commissioning, calibration, troubleshooting, service, operation, or remote monitoring of the battery pack 202. The GUI 1300 may allow a user to observe real-time or recorded battery module data, verify sensor operation, confirm balancing operation, identify abnormal cells, compare measured values to thresholds, and diagnose faults.

The GUI 1300 may further include additional information not shown in FIG. 13, such as pack voltage, pack current, state of charge, state of health, fault codes, warning codes, communication status, manual service disconnect status, coolant temperature, coolant flow status, relay status, contactor status, firmware version, serial number, event logs, or control commands.

The arrangement shown in FIG. 13 is illustrative and is not intended to limit the invention to the particular displayed values, units, layout, number of cells, or graphical format shown. In other embodiments, the GUI 1300 may display more or fewer cells, additional sensor values, different balancing indicators, graphical trends, alarms, color-coded status indicators, historical data, or other diagnostic information while still displaying battery module operating data generated by firmware or software associated with the battery module controller 640.

As described, for example, with reference to FIGS. 10A-Q, in embodiments of the present invention, one or more calibration resistors are measured and used to calibrate pressure gauge values obtained by the battery module controller. These calibration measurements ensure the accuracy of the pressure gauge values used to monitor for battery cell swelling or the presence of increased pressure in one or more cells of a battery module.

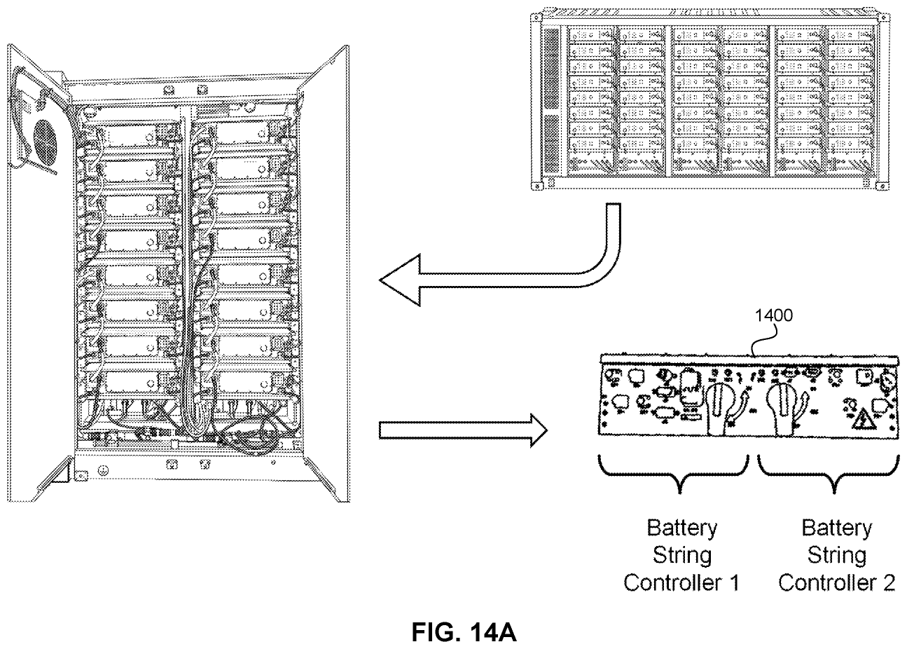

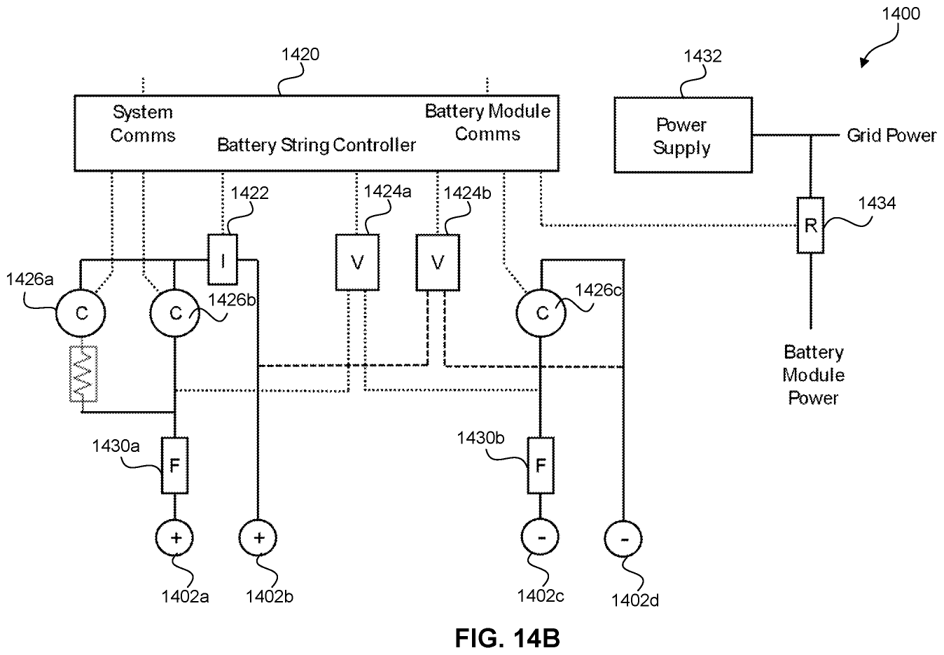

FIGS. 14A-B illustrate an example battery rack controller 1400 according to an embodiment of the present invention. As shown in FIG. 14A, battery rack controller 1400 includes a first string controller portion and a second string controller portion. These two string controller portions are housed in a single enclosure.

As shown in FIG. 14B, in an embodiment each string controller portion of battery rack controller 1400 includes four DC power connectors 1402a-1402d, two AC power connectors 1404a-1404b, two system level communications connectors 1406a-1406b, two battery module communications connectors 1408a-1408b, a status indicator 1410, and a power switch 1412. Battery rack controller 1400 can control a plurality of battery packs 202 as described herein.

The DC power connectors 1402a-1402d are used to connect the battery packs 202 of a battery rack to a DC bus of a battery energy storage system. In an embodiment, DC power connectors 1402a and 1402c connect battery rack controller 1400 to the energy storage system DC bus. Power connectors 1402b and 1402d connect battery rack controller 1400 to the battery modules that make up the battery rack. AC grid power is provided to battery rack controller 1400 using AC power connector 1404a. This power is then provided to the battery modules using AC power connector 1404b.

System level communications connectors 1406a-1406b are used to communicate to a higher-level energy storage system controller. In an embodiment, these communications are conducted using TCP/IP communications. Battery module communications connectors 1408a-1408b are used to communicate with the battery modules of the battery rack. In an embodiment, these communications are conducted using CANBus communications. In one embodiment, CANopen communications are used.

In embodiments of battery rack controller 1400, when powered-on, status indicator 1410 shows the status of the battery rack, for example, by a green light indicating everything is operating correctly, or by a yellow or a red light indicating that the battery rack has a minor or a major operating issue. Power switch 1412 is used to turn-on and turn-off power to battery rack controller 1400.

As shown in FIG. 14B, battery rack controller 1400 includes a battery rack controller circuit board 1420, a current meter 1422, two voltage meters 1424a-1424b, three contactors 1426a-1426c, a power resistor 1428, and two fuses 1430a-1430b. Battery rack controller circuit board 1420 includes a microcontroller unit that runs firmware and/or software that implements the functions of battery rack controller 1400. These functions include measuring the battery rack current, battery rack voltage, and communication data with the battery module controllers and the battery energy storage system controller. In operation, battery rack controller circuit board 1420 opens and closes contactors 1426 to connect the battery modules to the battery system DC bus. Contactor 1426a and power resistor 1428 are used for pre-charging and matching the voltage of the battery rack to the DC system bus before contactor 1426b is closed. If during operation an abnormal current or abnormal voltage is detected by current meter 1422 or one of the two voltage meters 1424a-1424b, then battery rack controller circuit board 1420 opens the contactors 1426 to isolate the battery rack from the DC system bus until the abnormal condition is corrected. Fuses 1430a-1430b are included in case of a short circuit or other overcurrent issue. In embodiments, fuses 1430 are very fast acting fuses.

As shown in FIG. 14B, battery rack controller 1400 includes a power supply 1432 to power the components of battery rack controller 1420. The power for this power supply is grid power. A relay 1434, controller by battery rack controller circuit board 1420 controls the supply of the grid power to the battery modules of the battery rack. In an embodiment, the opening and closing of relay 1434 can be used if needed to reset the battery module controllers of the battery modules that make up the battery rack.

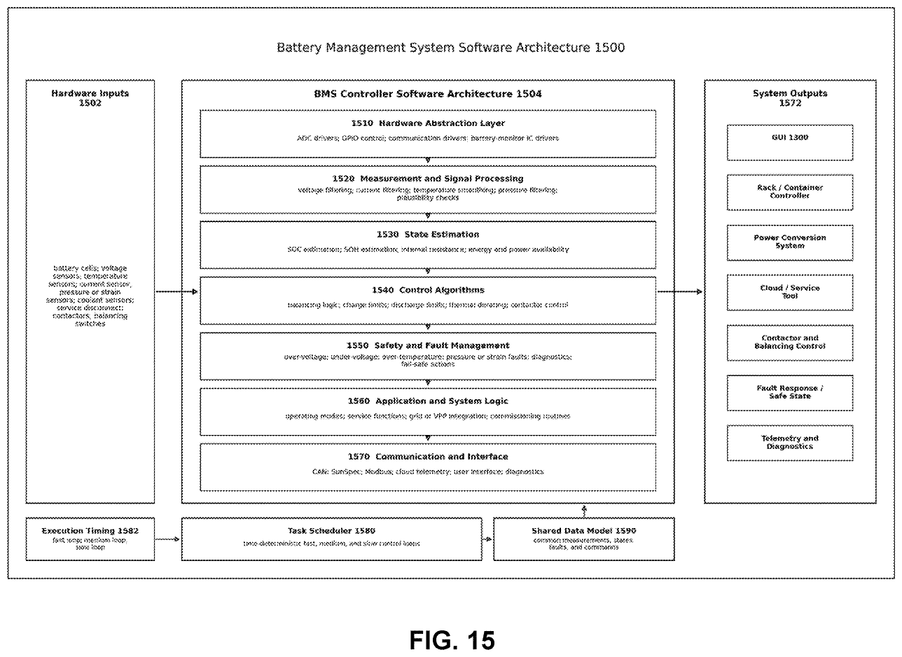

FIG. 15 illustrates an example battery management system software architecture 1500 according to an embodiment of the present invention. The software architecture 1500 may be executed by one or more battery module controllers described herein, including, for example, battery module controller 640.

The architecture 1500 may receive hardware inputs 1502 from battery cells, voltage sensors, temperature sensors, current sensors, pressure or strain sensors, coolant sensors, service-disconnect sensors, contactors, and balancing switches. The hardware inputs 1502 may be processed by a BMS controller software architecture 1504.

The BMS controller software architecture 1504 may include a hardware abstraction layer 1510, a measurement and signal processing layer 1520, a state estimation layer 1530, a control algorithm layer 1540, a safety and fault management layer 1550, an application and system logic layer 1560, and a communication and interface layer 1570.

The hardware abstraction layer 1510 may provide ADC drivers, GPIO control, communication drivers, and battery-monitor integrated circuit drivers. The measurement and signal processing layer 1520 may filter or validate voltage, current, temperature, pressure, strain, and other sensor measurements. The state estimation layer 1530 may determine state of charge, state of health, internal resistance, available energy, and available power.

The control algorithm layer 1540 may control cell balancing, charge limits, discharge limits, thermal derating, and contactor operation. The safety and fault management layer 1550 may detect over-voltage, under-voltage, over-temperature, pressure or strain faults, diagnostic failures, and other unsafe conditions, and may command fail-safe operation. The application and system logic layer 1560 may manage operating modes, service functions, commissioning routines, grid integration, or virtual power plant operation. The communication and interface layer 1570 may communicate data using CAN, SunSpec, Modbus, cloud telemetry, user interface data, or diagnostic messages.

The architecture 1500 may further include a task scheduler 1580 operating according to execution timing 1582. In some embodiments, the task scheduler 1580 executes fast, medium, and slow software loops to separate protection-critical control, estimation functions, diagnostics, logging, and communication tasks. The architecture 1500 may also include a shared data model 1590 that stores common measurements, states, faults, and commands used by multiple software layers.

The architecture 1500 may generate system outputs 1572, including GUI data, rack-level or container-level controller messages, power conversion system commands, cloud or service-tool data, contactor and balancing commands, telemetry, diagnostics, and fault-response or safe-state commands.

Those skilled in the relevant art(s) will readily appreciate that various adaptations and modifications of the exemplary embodiments described above can be achieved without departing from the scope and spirit of the present disclosure. Therefore, it is to be understood that, within the scope of the appended claims, the teachings of the disclosure may be practiced other than as specifically described herein.

What is claimed is:

1. A battery module controller for a battery pack, comprising:
a power conversion circuit configured to receive AC power from an external grid and to convert the AC power into a higher-frequency power signal;
a battery interface configured to generate a charging current based on the higher-frequency power signal and to deliver the charging current to a plurality of electrochemical cells of the battery pack; and
a controller in communication with the power conversion circuit and the battery interface, the controller configured to:
determine a charge condition of the battery pack; and
control the delivery of the charging current to at least one of the plurality of electrochemical cells based on the determined charge condition.

2. The battery module controller of claim 1, wherein the charging current is generated using energy derived from the external grid and is not derived from energy stored in the plurality of electrochemical cells.

3. The battery module controller of claim 1, wherein the power conversion circuit is configured to convert grid-frequency AC power into a higher-frequency AC power signal.

4. The battery module controller of claim 3, wherein the higher-frequency AC power signal is transformed to a lower AC voltage suitable for charging at least one of the plurality of electrochemical cells.

5. The battery module controller of claim 4, wherein the lower AC voltage is rectified to generate the charging current delivered to the at least one electrochemical cell.

6. The battery module controller of claim 5, wherein only one half cycle of the rectified AC voltage is used to generate the charging current for the at least one electrochemical cell.

7. The battery module controller of claim 6, wherein a first electrochemical cell is charged using a first half cycle of the rectified AC voltage and a second electrochemical cell connected in series with the first electrochemical cell is charged using a second half cycle opposite the first half cycle.

8. The battery module controller of claim 1, wherein the controller is configured to selectively deliver the charging current to subsets of the plurality of electrochemical cells to control a total current drawn from the external grid.

9. A method of managing a battery pack, comprising:
receiving AC power from an external grid;
converting, using a power conversion circuit, the AC power into a higher-frequency power signal;
generating a charging current based on the higher-frequency power signal;
delivering the charging current to a plurality of electrochemical cells of the battery pack;
determining a charge condition of the battery pack; and
controlling delivery of the charging current to at least one of the plurality of electrochemical cells based on the determined charge condition.

10. The method of claim 9, wherein the charging current is generated using energy derived from the external grid and is not derived from energy stored in the plurality of electrochemical cells.

11. The method of claim 9, wherein the converting comprises converting grid-frequency AC power into a higher-frequency AC power signal.

12. The method of claim 11, further comprising transforming the higher-frequency AC power signal to a lower AC voltage suitable for charging at least one of the plurality of electrochemical cells.

13. The method of claim 12, further comprising rectifying the lower AC voltage to generate the charging current delivered to the at least one electrochemical cell.

14. The method of claim 13, wherein the generating the charging current comprises using only one half cycle of the rectified AC voltage.

15. The method of claim 14, further comprising:
charging a first electrochemical cell using a first half cycle of the rectified AC voltage; and
charging a second electrochemical cell connected in series with the first electrochemical cell using a second half cycle opposite the first half cycle.

16. The method of claim 9, further comprising selectively delivering the charging current to subsets of the plurality of electrochemical cells to control a total current drawn from the external grid.

17. A battery pack, comprising:
a plurality of electrochemical cells; and
a battery module controller coupled to the plurality of electrochemical cells, the battery module controller comprising:
a power conversion circuit configured to receive AC power from an external grid and to convert the AC power into a higher-frequency power signal;
a battery interface configured to generate a charging current based on the higher-frequency power signal and to deliver the charging current to the plurality of electrochemical cells; and
a controller in communication with the power conversion circuit and the battery interface, the controller configured to:
determine a charge condition of the battery pack; and
control delivery of the charging current to at least one of the plurality of electrochemical cells based on the determined charge condition.

18. The battery pack of claim 17, wherein the charging current is generated using energy derived from the external grid and is not derived from energy stored in the plurality of electrochemical cells.

19. The battery pack of claim 17, wherein the power conversion circuit is configured to convert grid-frequency AC power into a higher-frequency AC power signal, and wherein the higher-frequency AC power signal is transformed to a lower AC voltage suitable for charging at least one of the plurality of electrochemical cells and rectified to generate the charging current.

20. The battery pack of claim 17, wherein a first electrochemical cell is charged using a first half cycle of a rectified AC signal and a second electrochemical cell connected in series with the first electrochemical cell is charged using a second half cycle opposite the first half cycle.
